(19) United States
(12) Patent Application Publication
(10) Pub. No.: US 2023/0189085 A1
(43) Pub. Date: Jun. 15, 2023

(54) METHOD AND APPARATUS FOR CELL CHANGE PREDICTION IN COMMUNICATION SYSTEM

(71) Applicant: ELECTRONICS AND TELECOMMUNICATIONS RESEARCH INSTITUTE, Daejeon (KR)

(72) Inventors: Hyun Seo PARK, Daejeon (KR); Yong Jin KWON, Daejeon (KR); Yun Joo KIM, Daejeon (KR); An Seok LEE, Daejeon (KR); Yu Ro LEE, Daejeon (KR); Heesoo LEE, Daejeon (KR); Sung Cheol CHANG, Daejeon (KR)

(73) Assignee: ELECTRONICS AND TELECOMMUNICATIONS RESEARCH INSTITUTE, Daejeon (KR)

(21) Appl. No.: 18/081,111

(22) Filed: Dec. 14, 2022

(30) Foreign Application Priority Data
Dec. 15, 2021 (KR) 10-2021-0179927
Nov. 29, 2022 (KR) 10-2022-0162406

(51) Int. Cl. H04W 36/00

(52) U.S. Cl. CPC H04W 36/0058; H04W 36/00837; H04W 36/00835; H04W 36/0061

(57) ABSTRACT

An operation method of a terminal may comprise: receiving, from a serving base station, measurement configuration information and measurement prediction configuration information; measuring signal strengths of the serving base station and a neighboring base station according to the measurement configuration information; predicting signal strengths of the serving base station and the neighboring base station based on a result of measuring the signal strengths of the serving base station and the neighboring base station, according to the measurement prediction configuration information; and transmitting, to the serving base station, a report message including the predicted signal strengths of the serving base station and the neighboring base station according to the measurement prediction configuration information.

### CROSS-REFERENCE TO RELATED APPLICATIONS

This application claims priority to Korean Patent Applications No. 10-2021-0179927, filed on Dec. 15, 2021, and No. 10-2022-0162406, filed on Nov. 29, 2022 with the Korean Intellectual Property Office (KIPO), the entire contents of which are hereby incorporated by reference.

### BACKGROUND

### 1. Technical Field

Exemplary embodiments of the present disclosure relate to a technique for predicting a cell change in a mobile communication system, and more specifically, to a technique for cell change prediction in a communication system, which facilitates prediction of a cell change time, an optimal cell, or a radio link failure (RLF) of a terminal.

### 2. Related Art

With the development of information and communication technologies, various wireless communication technologies are being developed. As the representative wireless communication technologies, there may be long term evolution (LTE), new radio (NR), or the like defined as the 3rd generation partnership project (3GPP) specifications. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g., Long Term Evolution (LTE) communication system or LTE-Advanced (LTE-A) communication system), the 5th generation (5G) communication system (e.g., new radio (NR) communication system) that uses a frequency band (e.g., a frequency band of 6 GHz or above) higher than that of the 4G communication system as well as a frequency band of the 4G communication system (e.g., a frequency band of 6 GHz or below) is being considered. The 5G communication system may support enhanced Mobile BroadBand (eMBB), Ultra-Reliable and Low-Latency Communication (URLLC), and massive Machine Type Communication (mMTC). In addition, even in a 5G advanced system, standardization is progressing with the goal of advancing the eMBB, mMTC, and URLLC service scenarios.

Meanwhile, the International Telecommunication Union (ITU) is developing international mobile telecommunication (IMT) frameworks and standards, and recently, is progressing discussions for 6G communication through the ‘IMT for 2030 and beyond’ program. In order to meet the requirements presented by the ‘IMT for 2030 and beyond’, a 6G communication system is expected to require development and standardization of core technologies for supporting immersive communication, sensing-integrated communication, critical communication, massive connectivity, and/or artificial intelligence (AI)-integrated communication.

In a mobile communication system, a handover technique provides service continuity according to movement of a terminal to provide seamless communication services. In the handover technique, since a handover time of the terminal is generally determined by a base station based on a result of signal strength measurement performed by the terminal, the handover time may be later than an optimal time. In addition, since a target cell is also determined by the base station, the target cell may not be an optimal target cell from the point of view of the terminal. Meanwhile, a radio link state in a handover region may not be good. As a result, it may be difficult that a signal strength measurement result reported from the terminal is delivered to the base station in real time. In addition, it may also be difficult that a handover command from the base station is delivered to the terminal in real time. On the other hand, the terminal may not be able to receive the handover command from the base station. Accordingly, the terminal may continue to be connected with a source cell even in a poor link state until a radio link failure (RLF) occurs. In this case, a data interruption time of the terminal may last until recovery of the RLF, and due to this, the communication quality of the terminal may be degraded when the RLF occurs.

### SUMMARY

Exemplary embodiments of the present disclosure provide a method and an apparatus for cell change prediction in a communication system, which facilitate prediction of a cell change time, an optimal cell, or an RLF of a terminal.

According to a first exemplary embodiment of the present disclosure, an operation method of a terminal may comprise: receiving, from a serving base station, measurement configuration information and measurement prediction configuration information; measuring signal strengths of the serving base station and a neighboring base station according to the measurement configuration information; predicting signal strengths of the serving base station and the neighboring base station based on a result of measuring the signal strengths of the serving base station and the neighboring base station, according to the measurement prediction configuration information; and transmitting, to the serving base station, a report message including the predicted signal strengths of the serving base station and the neighboring base station according to the measurement prediction configuration information.

The measurement prediction configuration information may include information on a second time, a first condition, and a second condition, and the terminal may be configured to perform: measuring the signal strengths of the serving base station and the neighboring base station at a first time according to the measurement configuration information; in response to that a first signal strength of the serving base station and a second signal strength of the neighboring base station measured at the first time satisfy the first condition, predicting a first predicted signal strength of the serving base station and a second predicted signal strength of the neighboring base station by using a first measurement prediction model according to the measurement prediction configuration information, the first predicted signal strength being a signal strength predicted for the serving base station to have at the second time, and the second predicted signal strength being a signal strength predicted for the neighboring base station to have at the second time; and in response to that the first predicted signal strength and the second predicted signal strength satisfy the second condition, transmitting the report message to the serving base station, the report message including information on the first predicted signal strength and the second predicted signal strength.

A first time difference between the first time and the second time may be a predetermined trigger time, which is a time to trigger (TTT).

The report message may be transmitted to the serving base station at a time between the first time and the second time.

The operation may further comprise, when the measurement prediction configuration information further includes a third time obtained by adding a minimum time-of-stay to the first time and information of a third condition, predicting a third predicted signal strength of the serving base station and a fourth predicted signal strength of the neighboring base station by using the first measurement prediction model, the third predicted signal strength being a signal strength predicted for the serving base station to have at the third time, and the fourth predicted signal strength being a signal strength predicted for the neighboring base station to have at the third time, wherein when the third predicted signal strength and the fourth predicted signal strength satisfy the third condition, the terminal does not transmit the report message to the serving base station.

The second condition may be an A3 event, and the A3 event may occur when the second predicted signal strength is higher than the first predicted signal strength by a first offset or more; and the third condition may be an A7 event, and the A7 event may occur when the third predicted signal strength is higher than the fourth predicted signal strength by the first offset or more.

The operation method may further comprise: predicting a fifth predicted signal strength of the serving base station and a sixth predicted signal strength of the neighboring base station by using the first measurement prediction model, the fifth predicted signal strength being a signal strength predicted for the serving base station to have at a fourth time between the first time and the second time, and the sixth predicted signal strength being a signal strength predicted for the neighboring base station to have at the fourth time, wherein when the fifth predicted signal strength and the sixth predicted signal strength do not satisfy the second condition, the terminal does not transmit the report message to the serving base station.

The operation method may further comprise: receiving, from the serving base station, information on a fifth time and a fourth condition and model feedback configuration information requesting transmission of a model feedback signal for the first measurement prediction model; obtaining a measured signal strength by measuring a signal strength of the serving base station at the fifth time; predicting a predicted signal strength predicted for the serving base station to have at the fifth time by using the first measurement prediction model; and transmitting the model feedback signal to the serving base station when the measured signal strength and the predicted signal strength satisfy the fourth condition.

The transmitting of the model feedback signal may comprise: transmitting an information availability indicator notifying presence of the model feedback signal to the serving base station when the measured signal strength and the predicted signal strength satisfy the fourth condition; receiving a report request of the model feedback signal from the serving base station; and transmitting the model feedback signal including information on the measured signal strength and the predicted signal strength to the serving base station.

According to a second exemplary embodiment of the present disclosure, an operation method of a terminal may comprise: receiving, from a serving base station, target cell prediction information including a second time and a target cell prediction condition; measuring signal strengths of the serving base station and a neighboring base station at a first time; predicting signal strengths predicted for the serving base station and the neighboring base station to have at the second time by using a first target cell prediction model; predicting the neighboring base station as a target base station based on the measured signal strengths, the predicted signal strengths, and the target cell prediction condition; and transmitting, to the serving base station, a report message including information on the target base station.

The target cell prediction condition may be a condition for determining the neighboring base station as the target base station when the measured signal strength of the neighboring base station at the first time satisfies an A3 event and the predicted signal strength predicted for the neighboring base station to have at the second time satisfies the A3 event.

The operation method may further comprise: predicting signal strengths predicted for the serving base station and the neighboring base station to have at a third time obtained by adding a minimum time-of-stay to the first time by using the first target cell prediction model; and calculating a difference between the predicted signal strength predicted for the serving base station to have at the third time and the predicted signal strength predicted for the neighboring base station to have at the third time, wherein when the difference satisfies a predetermined condition, the report message is not transmitted to the serving base station.

The operation method may further comprise: receiving, from the serving base station, model feedback configuration information requesting transmission of a model feedback signal for the first target cell prediction model; predicting a target cell fitness level of a first base station before handover to the first base station by using the first target cell prediction model; measuring a target cell fitness level of the first base station after the handover to the first base station; and transmitting the model feedback signal to the target base station when the predicted target cell fitness level and the measured target cell fitness level satisfy a predetermined condition.

According to a third exemplary embodiment of the present disclosure, an operation method of a terminal may comprise: receiving, from a serving base station, radio link failure (RLF) prediction information including information on a prediction time and an RLF condition; predicting a signal strength predicted for the serving base station to have at the prediction time by using an RLF prediction model; and in response to that the predicted signal strength of the serving base station satisfies the RLF condition, transmitting, to the serving base station, a report message including information on the predicted signal strength.

The operation method may further comprise: in response to that the predicted signal strength of the serving base station satisfies the RLF condition, declaring an RLF; and performing an RLF recovery procedure with another base station.

The operation method may further comprise: receiving, from the serving base station, model feedback configuration information requesting transmission of a model feedback signal for the RLF prediction model; predicting a signal strength predicted for the serving base station to have at the prediction time by using the RLF prediction model; measuring a signal strength of the serving base station at the prediction time; and in response to that the predicted signal strength and the measured signal strength satisfy a predetermined condition, transmitting the model feedback signal to the serving base station.

According to the present disclosure, a terminal can predict received signal strengths for a serving cell and neighboring cells to have after a specific time. In addition, the terminal can determine in advance a time for cell change and an optimal target cell based on the prediction result. Accordingly, the terminal can perform a handover procedure in advance based on the prediction result with accuracy similar to the conventional handover procedure. As a result, it is possible to increase a handover success rate while maintaining a similar ping-pong occurrence probability.

In addition, according to the present disclosure, a terminal can predict occurrence of a ping-pong handover based on a prediction result of received signal strengths after a specific time. In this case, the terminal can reduce a ping-pong occurrence probability by not performing handover to a neighboring cell for which occurrence of a ping-pong handover is predicted.

In addition, according to the present disclosure, a terminal can determine an optimal target cell by predicting occurrence of an RLF in advance. Since the terminal can determine an optimal target cell before an RLF occurs and perform a cell change, communication quality deterioration can be minimized when the RLF actually occurs. In this case, the terminal can perform handover to the target cell by quickly performing a handover procedure, or can perform a recovery procedure to the target cell more quickly by declaring the RLF in advance.

### BRIEF DESCRIPTION OF DRAWINGS

FIG. 1 is a conceptual diagram illustrating a first exemplary embodiment of a communication system.

FIG. 2 is a block diagram illustrating a first exemplary embodiment of a communication node constituting a communication system.

FIG. 3 is a conceptual diagram illustrating a first exemplary embodiment of a handover execution time in a communication system.

FIG. 4 is a conceptual diagram illustrating a second exemplary embodiment of a handover execution time in a communication system.

FIG. 5 is a sequence chart illustrating a first exemplary embodiment of a method for measuring and reporting received signal strengths in a communication system.

FIG. 6 is a sequence chart illustrating a first exemplary embodiment of a method for predicting and reporting received signal strength measurements in a communication system.

FIG. 7 is a conceptual diagram illustrating a third exemplary embodiment of a handover execution time in a communication system.

FIG. 8 is a block diagram illustrating a first exemplary embodiment of a cell change prediction apparatus in a communication system.

FIG. 9 is a sequence chart illustrating a first exemplary embodiment of a measurement prediction model feedback method in a communication system.

FIG. 10 is a sequence chart illustrating a first exemplary embodiment of a target cell prediction method in a communication system.

FIG. 11 is a sequence chart illustrating a first exemplary embodiment of a target cell prediction model feedback method in a communication system.

FIG. 12 is a sequence chart illustrating a first exemplary embodiment of an RLF prediction method in a communication system.

FIG. 13 is a sequence chart illustrating a first exemplary embodiment of an RLF recovery method in a communication system.

FIG. 14 is a sequence chart illustrating a first exemplary embodiment of a RLF prediction model feedback method in a communication system.

FIG. 15 is a sequence chart illustrating a first exemplary embodiment of a prediction activation method for a terminal in a communication system.

FIG. 16 is a sequence chart illustrating a first exemplary embodiment of a prediction deactivation method for a terminal in a communication system.

### DETAILED DESCRIPTION OF THE EMBODIMENTS

Exemplary embodiments of the present disclosure are disclosed herein. However, specific structural and functional details disclosed herein are merely representative for purposes of describing exemplary embodiments of the present disclosure. Thus, exemplary embodiments of the present disclosure may be embodied in many alternate forms and should not be construed as limited to exemplary embodiments of the present disclosure set forth herein.

Accordingly, while the present disclosure is capable of various modifications and alternative forms, specific exemplary embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular exemplary embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

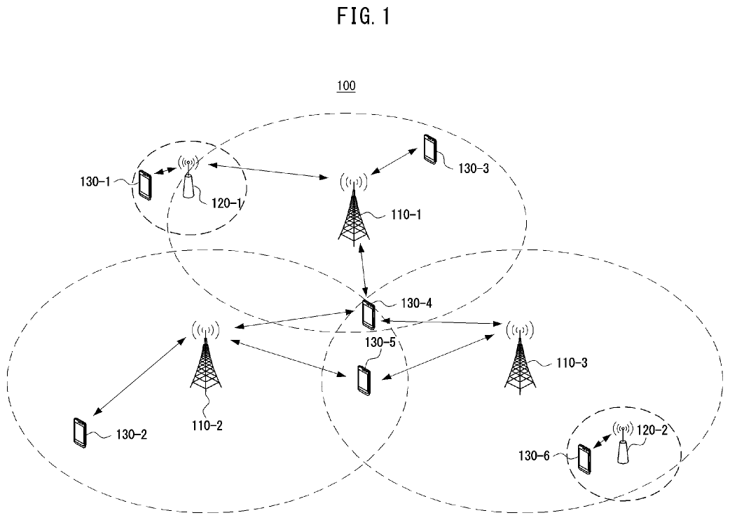

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Here, the communication system may be referred to as a ‘communication network’. Each of the plurality of communication nodes may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform-spread-OFDM (DFT-s-OFDM) based communication protocol, orthogonal frequency division multiple access (OFDMA) based communication protocol, single-carrier FDMA (SC-FDMA) based communication protocol, non-orthogonal multiple access (NOMA) based communication protocol, generalized frequency division multiplexing (GFDM) based communication protocol, filter band multi-carrier (FBMC) based communication protocol, universal filtered multi-carrier (UFMC) based communication protocol, space division multiple access (SDMA) based communication protocol, or the like. Each of the plurality of communication nodes may have the following structure.

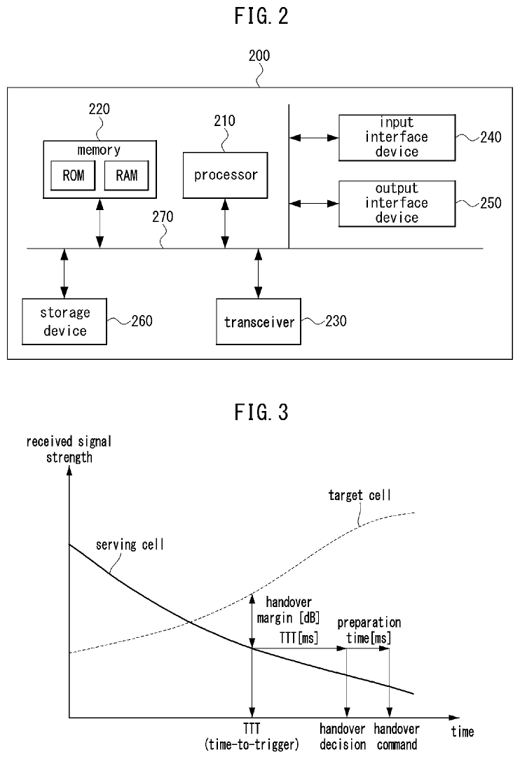

FIG. 2 is a block diagram illustrating a first exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. The respective components included in the communication node 200 may communicate with each other as connected through a bus 270. However, the respective components included in the communication node 200 may be connected not to the common bus 270 but to the processor 210 through an individual interface or an individual bus. For example, the processor 210 may be connected to at least one of the memory 220, the transceiver 230, the input interface device 240, the output interface device 250, and the storage device 260 through dedicated interfaces.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to the cell coverage of the first base station 110-1. Also, the second terminal 130-2, the fourth terminal 130-4, and the fifth terminal 130-5 may belong to the cell coverage of the second base station 110-2. Also, the fifth base station 120-2, the fourth terminal 130-4, the fifth terminal 130-5, and the sixth terminal 130-6 may belong to the cell coverage of the third base station 110-3. Also, the first terminal 130-1 may belong to the cell coverage of the fourth base station 120-1, and the sixth terminal 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), gNB, advanced base station (ABS), high reliability-base station (HR-BS), base transceiver station (BTS), radio base station, radio transceiver, access point (AP), access node, radio access station (RAS), mobile multihop relay-base station (MMR-BS), relay station (RS), advanced relay station (ARS), high reliability-relay station (HR-RS), home NodeB (HNB), home eNodeB (HeNB), road side unit (RSU), radio remote head (RRH), transmission point (TP), transmission and reception point (TRP), relay node, or the like. Each of the plurality of terminals 130-1, 130-2, 130-3, 130-4, 130-5, and 130-6 may be referred to as user equipment (UE), terminal equipment (TE), advanced mobile station (AMS), high reliability-mobile station (HR-MS), terminal, access terminal, mobile terminal, station, subscriber station, mobile station, portable subscriber station, node, device, on-board unit (OBU), or the like.

Each of the plurality of communication nodes 110-1, 110-2, 110-3, 120-1, 120-2, 130-1, 130-2, 130-3, 130-4, 130-5, and 130-6 may support cellular communication (e.g., LTE, LTE-Advanced (LTE-A), etc.) defined in the 3rd generation partnership project (3GPP) specification. Each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

Each of the plurality of base stations 110-1, 110-2, 110-3, 120-1, and 120-2 may support OFDMA-based downlink (DL) transmission, and SC-FDMA-based uplink (UL) transmission. In addition, each of the plurality of base stations 110-1, 110-2, 110-3, 120-1, and 120-2 may support a multi-input multi-output (MIMO) transmission (e.g., single-user MIMO (SU-MIMO), multi-user MIMO (MU-MIMO), massive MIMO, or the like), a coordinated multipoint (CoMP) transmission, a carrier aggregation (CA) transmission, a transmission in unlicensed band, a device-to-device (D2D) communication (or, proximity services (ProSe)), an Internet of Things (IoT) communication, a dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2).

In such the mobile communication system, a handover technique provides service continuity according to movement of the terminal to provide seamless communication services. Such the handover technique supports various requirements according to new service scenarios, application fields, and introduction of new technologies, and continues to evolve to improve performance. In the handover technique, it may not be easy to obtain optimal performance due to a trade-off between a handover failure probability, a ping-pong probability, and a throughput. Therefore, a mobility management technology is attracting attention as an important technology for optimizing user quality of experience (QoE) at a cell edge as well as the handover failure probability and ping-pong probability.

In such the mobile communication system, a terminal may perform handover when moving and changing a base station to which it accesses. The terminal may measure received signal strengths of a serving cell and a neighboring cell, and report the measurement result to the base station. The base station may receive the measurement result of the received signal strengths from the terminal, and may determine a target cell to perform handover based on the measurement result of the received signal strengths. The base station may instruct the determined target cell to prepare for the handover. In addition, the base station may transmit a handover command message to the terminal so that the terminal performs the handover. The terminal may receive the handover command message, and may perform the handover according to the received handover command message and attempt access to the target cell.

In this case, since a handover time of the terminal is generally determined by a base station based on a result of signal strength measurement performed by the terminal, the handover time may be later than an optimal time. In addition, since a target cell is also determined by the base station, the target cell may not be an optimal target cell from the point of view of the terminal. Meanwhile, a radio link state in a handover region may not be good. As a result, it may be difficult that a signal strength measurement result reported from the terminal is delivered to the base station in real time. In addition, it may also be difficult that a handover command from the base station is delivered to the terminal in real time.

On the other hand, the terminal may not be able to receive the handover command from the base station. Accordingly, the terminal may continue to be connected with a source cell even in a poor link state until an RLF occurs. In this case, a data interruption time of the terminal may last until recovery of the RLF, and due to this, the communication quality of the terminal may be degraded when the RLF occurs.

FIG. 3 is a conceptual diagram illustrating a first exemplary embodiment of a handover execution time in a communication system.

Referring to FIG. 3, in a communication system, a terminal may measure received signal strengths of a serving base station covering a serving cell and neighboring base stations including a target base station covering a target cell. For example, the terminal may measure a reference signal received power (RSRP) of each of the neighboring base stations. Here, the communication system may be the same as or similar to the communication system 100 of FIG. 1. In addition, a structure of each of the terminal, the serving base station, and the neighboring base stations may be the same as or similar to the structure of the communication node 200 of FIG. 2.

The terminal may determine whether a state in which a difference between the received signal strength of the target base station and the received signal strength of the serving base station is equal to or greater than a handover margin (HOM) continues for a predetermined time. For example, when the difference between the received signal strength of the target base station and the received signal strength of the serving base station is greater than or equal to the HOM for a predetermined trigger time (e.g., time to trigger (TTT)), the terminal may transmit a measurement report (MR) message to the serving base station. Here, the MR message may include channel state information including information on the received signal strength of each of the serving base station and the target base station. The HOM may be a first offset of an A3 event. The A3 event may refer to a case where the received signal strength of the target base station is greater by the first offset or more than the received signal strength of the serving base station.

The serving base station may receive the MR message from the terminal. The serving base station may determine a handover of the terminal based on the respective received signal strengths of the serving base station and the target base station included in the MR message. In this case, the serving base station may transmit a handover preparation message to the target base station for the handover of the terminal. The target base station may receive the handover preparation message from the serving base station. The target base station may determine whether to accept the handover of the terminal based on the handover preparation message. When the target base station accepts the handover of the terminal, the target base station may transmit a handover preparation response message to the serving base station.

The serving base station may receive the handover preparation response message from the target base station. The serving base station may transmit a handover command (i.e., HO CMD) message for instructing the terminal to perform the handover indicated by in the handover preparation response message. Here, the handover command message may be included in a radio resource control (RRC) reconfiguration message transmitted from the serving base station to the terminal. Accordingly, the terminal may receive, from the serving base station, the handover command message indicating the handover prepared by the target base station.

Meanwhile, in a handover region, a radio link state between the serving base station and the terminal may not be good. Therefore, the serving base station may not be able to receive the MR message transmitted from the terminal in real time. In addition, the terminal may not be able to receive the handover command message transmitted from the serving base station in real time. Therefore, the handover may fail depending on the radio link state between the terminal and the serving base station, and a data interruption time may increase due to occurrence of the handover failure during the handover operation. Accordingly, the communication quality may be degraded.

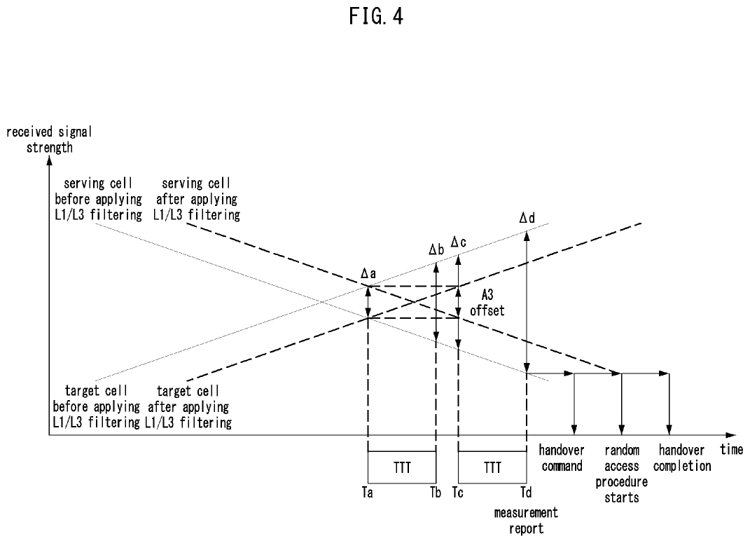

FIG. 4 is a conceptual diagram illustrating a second exemplary embodiment of a handover execution time in a communication system.

Referring to FIG. 4, in a communication system, a terminal may measure received signal strengths of a serving base station covering a serving cell and neighboring base stations including a target base station covering a target cell. In this case, a variation of the received signal strength in the actual radio channel may be large due to effects such as fading. Therefore, the terminal may apply a layer 1 (L1) filtering to obtain an average value for a predetermined time, and use the average value as the received signal strength. In this case, a difference Δa between a received signal strength of the target base station and a received signal strength of the serving base station at a time Ta may be greater than or equal to a HOM. In addition, a difference Δb between a received signal strength of the target base station and a received signal strength of the serving base station at a time Tb may be greater than or equal to the HOM, and a time difference between Tb and Ta may exceed a trigger time (i.e., TTT).

Meanwhile, the terminal may further apply a layer 3 (L3) filtering to a value obtained by applying the L1 filtering in order to reduce ping-pong and to reliably determine the handover without influence of fading effects. The terminal may apply the L3 filtering by multiplying the resultant value obtained from the L1 filtering by weights, thereby obtaining an exponentially weighted average value, and use the obtained weighted average value as a final received signal strength. In this manner, the terminal may reliably determine the handover without influence of fading effects while reducing the ping-pong phenomenon.

In this case, a difference Δc between a received signal strength of the target base station and a received signal strength of the serving base station at a time Tc may be greater than or equal to the HOM. In addition, a difference Δd between a received signal strength of the target base station and a received signal strength of the serving base station at a time Td may be greater than or equal to the HOM, and a time difference between Td and Tc may exceed the trigger time (i.e., TTT). In this case, based on the A3 offset, the time Ta may be a handover time to which only the L1 filtering is applied. However, the handover time may be delayed to the time Tc when the L3 filtering is applied. In addition, if the trigger time is applied, the handover time may be further delayed to the time Td. Here, although the L1 filtering, the L3 filtering, and the trigger time are used to reliably determine the handover, an occurrence probability of a handover failure may increase due to the delay of the handover time due to the L1 filtering, the L3 filtering, and/or the trigger time.

Meanwhile, the terminal may transmit an MR message to the serving base station at the time Td, and the serving base station may receive the MR message from the terminal. The serving base station may determine the handover of the terminal based on the received signal strengths of the serving base station and neighboring base stations included in the MR message. In this case, the serving base station may transmit a handover preparation message to the target base station to which the terminal is to perform handover. The target base station may receive the handover preparation message from the serving base station. The target base station may determine whether to accept the handover of the terminal based on the handover preparation message. When the target base station accepts the handover of the terminal, the target base station may transmit a handover preparation response message to the serving base station.

The serving base station may receive the handover preparation response message from the target base station. The serving base station may transmit, to the terminal, a handover command message for instructing the terminal to perform the handover indicated by the handover preparation response message. In this case, a state of a radio link between the serving base station and the terminal may not be good. As a result, an occurrence probability of a handover failure may increase. Here, the handover command message may be included in an RRC reconfiguration message transmitted from the serving base station to the terminal. The terminal may receive the handover command message from the serving base station. After receiving the handover command message, the terminal may initiate a random access procedure by transmitting a random access preamble to the target base station after acquiring downlink synchronization with the target base station. Thereafter, the terminal may acquire uplink synchronization through the random access procedure, and then transmit a handover complete message to the target base station to complete the handover. Here, the random access procedure may be performed in a good radio link state with the target base station. As a result, a probability of error occurrence in the random access procedure may be low. In addition, the handover complete message may also be transmitted in a good radio link state with the target base station. As a result, a probability of error occurrence in transmission of the handover complete message may be low.

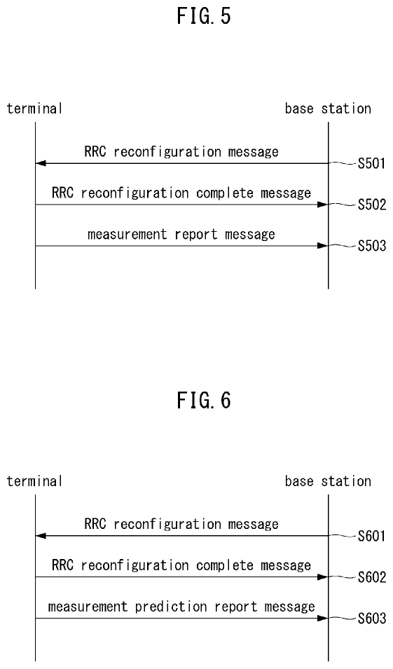

FIG. 5 is a sequence chart illustrating a first exemplary embodiment of a method for measuring and reporting received signal strengths in a communication system.

Referring to FIG. 5, a base station may generate signal strength measurement configuration information according to capability of a terminal, network configuration information, and the like. Then, the base station may configure the signal strength measurement configuration information as a measurement configuration information element (IE) (i.e., MeasConfig IE), and transmit it to the terminal by including it in an RRC reconfiguration message (S501). Accordingly, the terminal may receive the RRC reconfiguration message including the measurement configuration IE from the base station. The terminal may perform signal strength measurement according to the signal strength measurement configuration information according to the measurement configuration IE, and the terminal may transmit an RRC reconfiguration complete message to the base station in response (S502). Then, the base station may receive the RRC reconfiguration complete message from the terminal.

The measurement configuration IE may be configured as shown in Table 1 below. In the measurement configuration IE, ‘measObjectToRemoveList’ may provide a list of measurement objects to be removed. In the measurement configuration IE, ‘measObjectToAddModList’ may provide a list of measurement objects to be added or modified. In the measurement configuration IE, ‘reportConfigToRemoveList’ may provide a list of measurement report objects to be removed. In the measurement configuration IE, ‘reportConfigToAddModList’ may provide a list of measurement report objects to be added or modified. In the measurement configuration IE, ‘quantityConfig’ may provide L3 filtering configuration information. In the measurement configuration IE, ‘measIdToRemoveList’ may provide a list of identifiers to be deleted from a measurement identifier list of measurement objects. In the measurement configuration IE, ‘measIdToAddModList’ may provide a list of identifiers to be added or modified to or from the measurement identifier list of measurement objects. In the measurement configuration IE, ‘s-MeasureConfig’ may be a configuration not to perform measurement on neighboring cells when a received signal strength of the serving cell is greater than or equal to a specific threshold.

```
TABLE 1
-- ASN1START
-- TAG-MEASCONFIG-START
MeasConfig ::= SEQUENCE {
  measObjectToRemoveList MasObjectToRemoveList  OPTIONAL, -- Need N
  measObjectToAddModList MeasObjectToAddModList OPTIONAL, -- Need N
  reportConfigToRemoveList ReportConfigToRemoveList OPTIONAL, -- Need N
  reportConfigToAddModList ReportConfigToAddModList OPTIONAL, -- Need N
  measIdToRemoveList MeasIdToRemoveList OPTIONAL, -- Need N
  measIdToAddModList MeasIdToAddModList OPTIONAL, -- Need N
  s-MeasureConfig CHOICE {
    ssb-RSRP RSRP-Range,
    csi-RSRP RSRP-Range
  }  OPTIONAL, -- Need M
  quantityConfig Quantity Config OPTIONAL, -- Need M
  measGapConfig  MeasGapConfig OPTIONAL, -- Need M
  measGapSharingConfig MeasGapSharingConfig OPTIONAL, -- Need M
  ...,
  [[
  interFrequencyConfig-NoGap-r16 ENUMERATED {true} OPTIONAL -- Need R
  ]]
}
MeasObjectToRemoveList ::=  SEQUENCE(SIZE (1..maxNrofObjectId)) OF MeasObjectId
MeasIdToRemoveList ::= SEQUENCE(SIZE(1..maxNrofMeasId)) OF MeasId
ReportConfigToRemoveList::=  SEQUENCE(SIZE(1..maxReportConfigId)) OF ReportConfigId
-- TAG-MEASCONFIG-STOP
-- ASN1STOP
```

Meanwhile, the terminal may measure a received signal strength (e.g., reference signal received power (RSRP), reference signal received quality (RSRQ), or signal to interference-plus-noise ratio (SINR)) of the neighboring base station according to the signal strength measurement configuration information of the measurement configuration IE. Then, the terminal may periodically report a signal strength measurement result including the received signal strength of the neighboring base station to the base station through an MR message according to measurement report configuration (S503). Alternatively, when the received signal strength of the neighboring base station satisfies a specific event according to the measurement report configuration, the terminal may report the signal strength measurement result including the measured received signal strength of the neighboring base station to the base station through the MR message. The MR message may be configured as shown in Table 2 below.

```
TABLE 2
-- ASN1START
-- TAG-MEASUREMENTREPORT-START
MeasurementReport ::=  SEQUENCE {
  criticalExtensions CHOICE {
    measurementReport MeasurementReport-IEs,
    criticalExtensionsFuture  SEQUENCE { }
  }
}
MeasurementReport-IEs ::= SEQUENCE {
  measResults MeasResults,
  lateNonCriticalExtension OCTET STRING  OPTIONAL,
  nonCriticalExtension SEQUENCES { }  OPTIONAL
}
-- TAG-MEASUREMENTREPORT-STOP
-- ASN1STOP
```

Then, the base station may receive the MR message from the terminal. Here, the MR message may include measurement result IE (i.e., MeasResults IE) that is the signal strength measurement result. The measurement result IE may be shown in Table 3 below.

```
TABLE 3
--ASN1START
--TAG-MEASRESULTS-START
MeasResults ::= SEQUENCE {
measId MeasId,
measResultServingMOList MeasResultServMOList,
measResultNeighCells CHOICE {
  measResultListNR MeasResultListNR,
  ...,
measResultListEUTRA  MeasResultListEUTRA,
measResultListUTRA-FDD-r16  MeasResultListUTRA-FDD-r16
sl-MeasResultsCandRelay-r17  OCTET STRING-Contains PC5 SL-MeasResultListRelay-r17
} OPTIONAL,
  ...,
  [[
  measResultServFreqListEUTRA-SCGMeasResultServFreqListEUTRA-SCG OPTIONAL,
  measResultServFreqListNR-SCG MeasResultServFreqListNR-SCG OPTIONAL,
  measResultSFTD-EUTRA MeasResultSFTD-EUTRA OPTIONAL,
  measResultSFTD-NR MeasResultCellSFTD-NR OPTIONAL
  ]],
  [[
  measResultCellListSFTD-NR  MeasResultCellListSFTD-NR OPTIONAL
  ]],
  [[
  measResultForRSSI-r16 MeasResultForRSSI-r16 OPTIONAL,
  locationInfo-r16 LocationInfo-r16 OPTIONAL,
  ul-PDCP-DelayValueResultList-r16 UL-PDCP-DelayValueResultList-r16 OPTIONAL,
  measResultsSL-r16 MeasResultsSL-r16 OPTIONAL,
  measResultCLI-r16 MeasResultCLI-r16 OPTIONAL
  ]]
    [[
  measResultsRxTxTimeDiff-r17 MeasResultRxTxTimeDiff-r17 OPTIONAL
    sl-MeasResultsServingRelay-r17  OCTET STRING  OPTIONAL,
                                                    -Contains PC5 SL-
MeasResultRelay-r17
  ul-PDCP-ExcessDelayResultList-r 17 ul-PDCP-ExcessDelayResultList-r17 OPTIONAL,
  coarseLocationInfo-r17  OCTET STRING OPTIONAL
  ]]
}
```

Meanwhile, a terminal mobility prediction technique may predict a received signal strength measurement value of the terminal. Such the terminal mobility prediction technique may aim to predict a terminal mobility based on a predicted received signal strength measurement value of the terminal and to determine an optimal target cell in advance based on the predicted terminal mobility. Such the terminal mobility prediction technique may predict a received signal strength measurement value of the terminal by executing an artificial intelligence (AI) algorithm and/or machine learning (ML) algorithm. In addition, the terminal mobility prediction technique may determine an optimal target cell in advance based on the received signal strength measurement value of the terminal, which is predicted by executing the AI algorithm and/or ML algorithm. To this end, the terminal mobility prediction technique may consider options for configuring model training or model inference.

Here, the artificial intelligence (AI) is a field of computer engineering and information technology that studies ways to enable computers to do thinking, learning, and self-development that can be done with human intelligence, and may refer to enabling computers to mimic intelligent human behavior. In addition, machine learning (ML) is a field of the artificial intelligence, which includes a field of study that gives computers the ability to learn without explicit programming. Specifically, the machine learning may be performed based on empirical data, may make predictions, and may be said to be a technology that can research and build systems that improve their performance and algorithms for themselves. The algorithms in machine learning may take a form of building a specific model to derive predictions or decisions based on input data, rather than executing rigidly defined static program instructions.

The terminal mobility prediction technique based on the terminal may utilize more data without problems such as privacy than the terminal mobility prediction technique based on the base station. Therefore, the terminal mobility prediction technique can obtain better performance when designed based on the terminal than when designed based on the base station. In contrast, the base station may have more information such as cell deployment information enabling more accurate mobility prediction than the terminal. Therefore, model training may achieve better performance when based on the base station than when based on the terminal.

FIG. 6 is a sequence chart illustrating a first exemplary embodiment of a method for predicting and reporting received signal strength measurements in a communication system.

Referring to FIG. 6, a base station may generate signal strength measurement prediction configuration information as needed for a terminal capable of signal strength measurement prediction according to capability of the terminal, network configuration information, and the like. Then, the base station may configure the signal strength measurement prediction configuration information as a measurement prediction configuration IE (i.e., MeasPredictionConfig IE), and transmit it to the terminal by including it in an RRC reconfiguration message (S601). Accordingly, the terminal may receive the RRC reconfiguration message including the measurement prediction configuration IE from the base station. The terminal may perform signal strength measurement prediction according to the signal strength measurement prediction configuration information of the measurement prediction configuration IE. Then, the terminal may transmit an RRC reconfiguration complete message to the base station in response (S602). Then, the base station may receive the RRC reconfiguration complete message from the terminal.

Meanwhile, the terminal may measure a received signal strength (e.g., RSRP, RSRQ, or SINR) of a neighboring base station according to the signal strength measurement prediction configuration information. In addition, the terminal may predict a received signal strength for a time after a specific time based on the measured received signal strength. That is, the terminal may predict a received signal strength for a time after a specific time from a signal strength measurement result.

Then, the terminal may periodically report, to the base station, the signal strength measurement prediction result including the predicted received signal strength of the neighboring base station through a measurement prediction report message according to measurement prediction report configuration (S603). Alternatively, when the predicted received signal strength of the neighboring base station satisfies a specific event according to the measurement prediction report configuration, the terminal may transmit, to the base station, the signal strength measurement prediction result including the predicted received signal strength of the neighboring base station through the measurement prediction report message.

Then, the base station may receive the measurement prediction report message from the terminal. Here, the measurement prediction report message may include a measurement prediction result IE (i.e., MeasPredictionResults IEs) including the signal strength measurement prediction result.

Meanwhile, the base station may be configured to include the measurement prediction configuration IE including the signal strength measurement prediction configuration information in the measurement configuration IE. In addition, the terminal may transmit the signal strength measurement prediction result to the base station using the MR message instead of the measurement prediction report message. In addition, the terminal may be configured to include the measurement prediction result IE, which is the signal strength measurement prediction result, in the measurement result IE.

Meanwhile, the base station may configure the signal strength measurement prediction as needed for a terminal capable of signal strength measurement prediction according to capability of the terminal. To this end, the base station may set a measurement prediction flag (i.e., measPredictionFlag) in the RRC reconfiguration message and transmit it to the terminal. Then, the terminal may receive the RRC reconfiguration message including the measurement prediction flag from the base station. Thereafter, the terminal may transmit an RRC reconfiguration complete message to the base station in response, and then the terminal may perform signal strength measurement prediction by itself.

Meanwhile, when a specific event occurs according to the signal strength measurement prediction configuration information, the terminal may transmit a measurement prediction report message to the base station to report the signal strength measurement prediction result to the base station. For example, a signal strength measurement prediction result at a specific time t1 may satisfy an A3 event entry condition. In addition, if a signal strength measurement prediction result from the time t1 to a time (t1+t2) continues to satisfy the A3 event entry condition, the terminal may transmit a measurement prediction report message to the base station at the time t1 to report the signal strength measurement prediction result to the base station and prepare for a handover in advance. Alternatively, the terminal may report the signal strength measurement prediction result by transmitting a measurement prediction report message to the base station at the time (t1+t2) and may prepare for a handover in advance. In this case, t2 may be a trigger time (i.e., TTT).

Meanwhile, when the terminal identifies occurrence of a specific event according to the signal strength measurement configuration information and identifies occurrence of a specific event according to the signal strength measurement prediction configuration information, the terminal may transmit a measurement prediction report message to the base station to report the signal strength measurement prediction result.

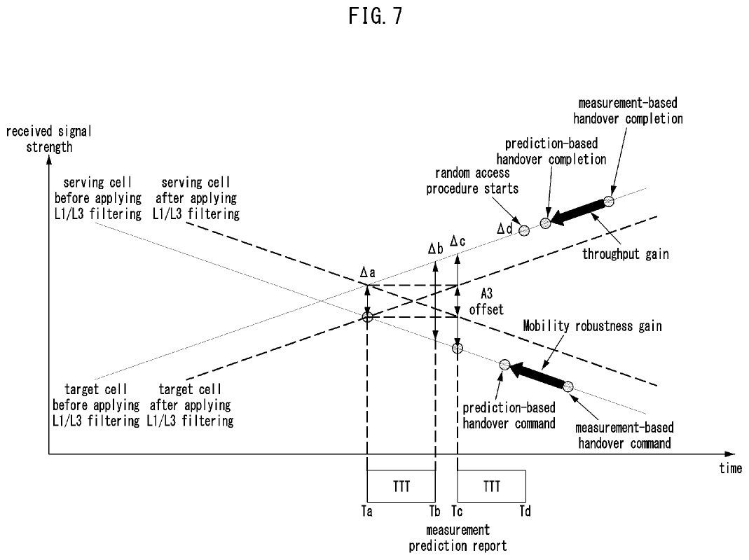

FIG. 7 is a conceptual diagram illustrating a third exemplary embodiment of a handover execution time in a communication system.

Referring to FIG. 7, in a communication system, a terminal may measure received signal strengths of a serving base station covering a serving cell and neighboring base stations including a target base station covering a target cell. In this case, a variation of the received signal strength in the actual radio channel may be large due to effects such as fading. Therefore, the terminal may apply an L1 filtering to obtain an average value for a predetermined time and use the average value as the received signal strength. In this case, for example, a difference Δa between a received signal strength of the target base station and a received signal strength of the serving base station at a time Ta may be greater than or equal to a HOM (e.g., A3 offset). In addition, a difference Δb between a received signal strength of the target base station and a received signal strength of the serving base station at a time Tb may be greater than or equal to the HOM (e.g., A3 offset), and a time difference between Tb and Ta may exceed the trigger time (i.e., TTT).

Meanwhile, the terminal may further apply an L3 filtering to a value obtained by applying the L1 filtering in order to reduce ping-pong and to reliably determine the handover without influence of fading effects. The terminal may apply the L3 filtering by multiplying the resultant value obtained from the L1 filtering by weights, thereby obtaining an exponentially weighted average value, and use the obtained weighted average value as a final received signal strength. In this manner, the terminal may reliably determine the handover without influence of fading effects while reducing the ping-pong phenomenon.

In this case, a difference Δc between a received signal strength of the target base station and a received signal strength of the serving base station at a time Tc may be equal to or greater than the HOM (e.g., A3 offset).

Meanwhile, the terminal may calculate a predicted received signal strength of the serving base station at the time Tc by predicting a received signal strength predicted for the serving base station to have at a time Td. In addition, the terminal may calculate a predicted received signal strength of the target base station at the time Tc by predicting a received signal strength predicted for the target base station to have at the time Td. Of course, the terminal may calculate the received signal strength predicted for the serving base station to have at the time Td at a time earlier than the time Tc. In addition, the terminal may calculate the received signal strength predicted for the target base station to have at the time Td at a time earlier than the time Tc. In this case, a difference Δd between the predicted received signal strength of the target base station and the predicted received signal strength of the serving base station for the time Td may be greater than or equal to the HOM (e.g., A3 offset).

Then, the terminal may transmit, to the serving base station, a measurement prediction report message including information on the predicted received signal strength of the serving base station for the time Td and the predicted received signal strength of the target base station for the time Td. In addition, the measurement prediction report message may include information on the received signal strength of the serving base station and the received signal strength of the target base station measured at the time Tc. The serving base station may receive the measurement prediction report message from the terminal. The serving base station may determine a handover of the terminal based on the predicted received signal strengths of the serving base station and the target base station or based on the predicted received signal strengths of the serving base station and the target base station and the received signal strengths of the serving base station and the target base station included in the measurement prediction report message. In this case, the serving base station may transmit a handover preparation message to the target base station to which the terminal is to perform handover. The target base station may receive the handover preparation message from the serving base station. The target base station may determine whether to accept the handover of the terminal based on the handover preparation message. When the target base station accepts the handover of the terminal, the target base station may transmit a handover preparation response message to the serving base station.

The serving base station may receive the handover preparation response message from the target base station. The serving base station may transmit a handover command message for instructing the terminal to perform the handover indicated by the handover preparation response message. In this case, when a time required for handover preparation is shorter than the trigger time, the serving base station may transmit the handover command message to the terminal at a time between the time Tc and the time Td. The terminal may receive the handover command message from the serving base station. In this manner, the terminal may transmit the measurement prediction report message to the serving base station at the time Tc to trigger the handover more quickly. As a result, the terminal may receive the handover command message from the serving base station in a good radio link state, thereby reducing the handover failure probability. In addition, the terminal may access the target base station earlier with a better radio link state.

Here, a difference between a transmission time of the measurement-based handover command message and a transmission time of the prediction-based handover command message may be referred to as a mobility robustness gain. The terminal may obtain the mobility robustness gain by predicting the received signal strength and utilizing it for the handover. On the other hand, the terminal may apply the trigger time to the time Tc by operating the existing handover algorithm regardless of the prediction of received signal strength, and may trigger the handover at the time Td at the latest. Therefore, a handover with better handover failure probability performance can be guaranteed for the terminal than before in terms of mobility robustness.

Thereafter, after receiving the handover command message, the terminal may initiate a random access procedure by transmitting a random access preamble to the target base station after acquiring downlink synchronization with the target base station. In this case, a transmission time of the random access preamble may be earlier than the time Td. Thereafter, the terminal may complete the handover by transmitting a handover complete message to the target base station after acquiring uplink synchronization through the random access procedure. In this case, a difference between a transmission time of the prediction-based handover complete message and a transmission time of the measurement-based handover complete message may be referred to as a throughput gain. In this manner, the terminal may obtain the throughput gain during the handover process. On the other hand, the terminal may operate the existing handover algorithm regardless of the prediction of the received signal strength. Therefore, a handover with better throughput performance can be guaranteed for the terminal than before in terms of throughput gain.

On the other hand, when the terminal can predict received signal strengths for specific times between the time Tc and the time Td, the terminal may trigger the handover considering only the predicted result for the time Td regardless of the predicted results of received signal strengths for the specific times. Alternatively, when the terminal can predict received signal strengths for specific times between the time Tc and the time Td, the terminal may trigger the handover considering both the prediction results of the received signal strengths for the specific times and the prediction results for the time Td. That is, when both the prediction results of received signal strengths for the specific times between the times Tc and Td and the prediction results for the time Td are equal to or greater than the HOM (e.g., A3 offset), the terminal may trigger the handover.

The performance index of the handover algorithm may include a ping-pong handover probability. A ping-pong handover may mean performing a handover from a cell 1 to a cell 2 and then performing a handover to the cell 1 again after accessing the cell 2 for a short time. The 3GPP defines a short cell access time for determining the ping-pong handover as a minimum time-of-stay (MTS) and may use 1 second as a reference value. The terminal may use a larger A3 offset or a larger trigger time in the handover algorithm to reduce the occurrence of ping-pong handover. However, if the terminal uses such the handover algorithm, the handover triggering may be delayed. As a result, the handover failure probability may increase as an adverse effect.

In a handover decision time, the terminal may additionally predict a received signal strength for a specific time after executing the handover. In this case, occurrence of a ping-pong handover may be predicted according to the prediction result for the specific time. In this case, the terminal may not perform the handover. For example, when a received signal strength is predicted at the time Tc, the terminal may predict a received signal strength for a time (Tc+MTS) as well as the time Td. As a result, the prediction result of the received signal strength for the time Td may satisfy the event A3. In this case, the terminal may trigger the handover. On the other hand, the prediction result of the received signal strength of the serving cell for the time (Tc+MTS) may be better by the A3 offset or more than the prediction result of the received signal strength of the target cell for the time (Tc+MTS). In this case, the terminal may trigger a handover to the serving cell again after executing the handover to the target cell. As a result, the possibility of ping-pong handover may be high. Accordingly, in this case, the terminal may not trigger the handover at the time Tc.

Meanwhile, the measurement prediction configuration IE may be configured as shown in Table 4 below.

```
TABLE 4
-- ASN1START
-- TAG-MEASCONFIG-START
MeasPredictionConfig ::= SEQUENCE {
  measPredID MeasPredID
    useModelID ModelID
    predictionConfig predictionConfig
    s-MeasurePredConfig  CHOICE{
      ssb-RSRP  RSRP-Range
      csi-RSRP  RSRP-Range
    }
  quantityPrdConfig quantityPrdConfig
  ...,
}
-- TAG-MEASCONFIG-STOP
-- ASN1STOP
```

In the measurement prediction configuration IE, ‘measPredId’ may provide a measurement prediction identifier of a measurement prediction object. In the measurement prediction configuration IE, ‘useModelId’ may provide an identifier of a machine learning model to be used for measurement prediction. The terminal may manage a measurement prediction machine learning model by itself. In this case, ‘useModelId’ may be omitted or ignored in the measurement prediction configuration IE. Alternatively, the base station may manage measurement prediction machine learning models. In this case, the base station may indicate information on the machine learning model to be used by transmitting information on the corresponding machine learning model identifier to the terminal. The terminal may receive the information on the machine learning model which includes the machine learning model identifier from the base station. The terminal may use the machine learning model by referring to the machine learning model identifier received from the base station through the measurement prediction configuration IE.

In the measurement prediction configuration IE, ‘predictionConfig’ may indicate prediction configuration information. Such the prediction configuration information may include ‘measId’. In the prediction configuration information, ‘measId’ may be an identifier of a measurement object on which prediction is to be performed. In addition, the prediction configuration information may include one or more [inputWindowSize, outputWindowSize] pairs. For example, a measurement period may be 40 msec. The terminal may perform separate predictions for a time (T1+TTT) and a time (T1+MTS) at a time T1. In addition, the terminal may make the prediction using a measurement result from 1 sec before the time T1 to the time T1. A trigger time (TTT) may be, for example, 160 msec. A minimum time-of-stay (MTS) may be 1 sec, for example.

In this case, inputWindowSize in the [inputWindowSize, outputWindowSize] pair may be 25 which is 1 sec/40 msec. When inputWindowSize is set to 25, the terminal may perform the prediction using a measurement result from 1 sec before the time T1 to the time T1. Further, one outputWindowSize in the [inputWindowSize, outputWindowSize] pair may be 4 which is 160 ms/40 msec. When outputWindowSize is set to 4, the terminal may predict a measurement result up to the time (T1+TTT) by using the measurement result from 1 sec before the time T1 to the time T1. Another outputWindowSize in the [inputWindowSize, outputWindowSize] pair may be 25 which is 1 sec/40 msec. when outputWindowSize is set to 25, the terminal may predict a measurement result up to the time (T1+MTS) by using the measurement result from 1 sec before the time T1 to the time T1. Accordingly, the serving base station may set the [inputWindowSize, outputWindowSize] pairs as [25, 4] and [25, 25].

Alternatively, the terminal may perform prediction for both the time (T1+TTT) and the time (T1+MTS) from one prediction. In this case, the serving base station may set the [inputWindowSize, outputWindowSize] pair to [25, 25]. The [inputWindowSize, outputWindowSize] pair may already be determined by a machine learning model. In this case, the [inputWindowSize, outputWindowSize] pair may be omitted or ignored. Alternatively, the serving base station may use a [inputWindowTime, outputWindowTime] pair having the same meaning instead of the [inputWindowSize, outputWindowSize] pair. For example, [1 sec, 160 msec] and [1 sec, 1 sec] may be set using direct time information in the above-described example.

Meanwhile, the prediction configuration information may include one or more sets of [event, duration, continuous, report_timestep] for the terminal to report a measurement prediction result to the base station as needed. Here, ‘event’ may be configured in the same format as the reportConfig field of the MeasConfig IE. In addition, ‘duration’ may be a time applied to identify whether a prediction result satisfies a corresponding event after a time corresponding to ‘duration’ when a measurement result satisfies the corresponding event. ‘Continuous’ may be a flag indicating whether the corresponding event according to the prediction result should be continuously satisfied during the time corresponding to ‘duration’ or satisfied only after the time corresponding to ‘duration’. ‘Report_timestep’ may be set as a timestep or a unit time for reporting the prediction results.

For example, the serving base station may configure the prediction configuration information so that the prediction result for the time (T1+TTT) and the prediction result for the time (T1+MTS) are reported when the event A3 is satisfied at the time T1 and the event A3 is also satisfied at the time (T1+TTT). In this case, the set of [event, duration, continuous, report_timestep] may be set to [A3 event, TTT, false, (4, 25)] or [A3 event, TTT, false, (160 msec, 1 sec)]. The measurement result of the time T1 may be reported together without separate configuration.

Alternatively, the serving base station may configure the terminal to report the prediction result for the time (T1+MTS) when the prediction result for the time (T1+MTS) indicates that the serving cell is better by the A3 offset than the target cell. To this end, the serving base station may define and use a new event. The existing A3 event may mean a case where the target cell is better by the A3 offset than the serving cell. Unlike this, the serving base station may newly define an A7 event. The newly defined A7 event may mean a case where the serving cell is better than the target cell by the A3 offset or more. In this case, the serving base station may set the set of [event, duration, continuous, report_timestep] to [A7 event, 0, false, (25)] or [A7 event, 0, false, (1 sec)]. The measurement result of the time T1 may be reported together without separate configuration.

Meanwhile, in the measurement prediction configuration IE, ‘s-MeasurePredConfig’ may be configured so as not to perform measurement prediction on received signal strengths of neighboring cells when a received signal strength of the serving cell is greater than or equal to a specific threshold. Alternatively, the serving base station may configure the terminal not to predict signal strengths when a received signal strength of a neighboring cell is less than a specific threshold or when a difference between a received signal strength of a neighboring cell and the received signal strength of the serving cell is less than a specific offset. ‘s-MeasurePredConfig’ may be configured in the same format as ‘s-MeasureConfig’ field of the MeasConfig IE. In the measurement prediction configuration IE, ‘quantityPredConfig’ may include configuration information of L3 filtering for measurement prediction. ‘quantityPredConfig’ may be configured in the same format as ‘quantnyConfig’ field of the MeasConfig IE.

Meanwhile, the measurement prediction configuration IE may be configured differently as shown in Table 5 below.

```
TABLE 5
-- ASNISTART
-- TAG-MEASCONFIG-START
MeasPredictionConfig ::= SEQUENCE {
measPredObjectToRemoveList  MasPredObjectToRemoveList   OPTIONAL, -- Need N
  measPredObjectToAddModList   MeasPredObjectToAddModList   OPTIONAL, -- Need N
  reportPredConfigToRemoveList  ReportPredConfigToRemoveList OPTIONAL, -- Need N
reportPredConfigToAddModList  ReportPredConfigToAddModList OPTIONAL, --Need N
measPredIdToRemoveList MeasPredIdToRemoveList OPTIONAL, -- Need N
measPredIdToAddModList MeasPredIdToAddModList OPTIONAL, -- Need N
s-MeasurePredConfig CHOICE {
    ssb-RSRP RSRP-Range,
    csi-RSRP RSRP-Range
}  OPTIONAL, -- Need M
quantityPredConfig  QuantityPredConfig OPTIONAL, -- Need M
...,
}
MeasPredObjectToRemoveList  ::= SEQUENCE(SIZE  (1..maxNrofObjectId)) OF
MeasPredObjectId
MeasPredIdToRemoveList ::=  SEQUENCE(SIZE(1..maxNrofMeasId)) OF MeasPredId
ReportPredConfigToRemoveList::= SEQUENCE(SIZE(1. .maxReportConfigId)) OF
ReportPredConfigId
-- TAG-MEASCONFIG-STOP
-- ASN1STOP
```

In the measurement prediction configuration IE, ‘measPredObjectToRemoveList’ may provide a list of measurement prediction objects to be deleted. In the measurement prediction configuration IE, ‘measPredObjectToAddModList’ may provide a list of measurement prediction objects to be added or modified. In the measurement prediction configuration IE, ‘reportPredConfigToRemoveList’ may provide a list of measurement prediction objects to be deleted from the measurement prediction report configuration. In the measurement prediction configuration IE, ‘reportPredConfigToAddModList’ may provide a list of measurement prediction objects to be added to or modified in the measurement prediction report configuration. In the measurement prediction configuration IE, ‘quantityPredConfig’ may include configuration information of L3 filtering for measurement prediction. In the measurement prediction configuration IE, ‘measPredIdToRemoveList’ may provide a list of measurement prediction identifiers to be removed from the measurement prediction identifier list. In the measurement prediction configuration IE, ‘measPredIdToAddModList’ may provide a list of measurement prediction identifiers to be added to or modified in the measurement prediction identifier list. In the measurement prediction configuration IE, ‘s-MeasurePredConfig’ may provide information for configuring not to predict received signal strengths of neighboring cells when a received signal strength of the serving cell is equal to or greater than a specific threshold. In the measurement prediction configuration IE, each field of MeasPredictionConfig IE may be configured in the same format as each field of the MeasConfig IE.

The aforementioned ‘measPredId’ may be included in ‘measPredIdToAddModList’. The aforementioned ‘useModelId’ may be included in ‘measPredIdToAddModList’. The aforementioned pair [inputWindowSize, outputWindowSize] may be included in ‘measPredObjectToAddModList’. The aforementioned set of [event, duration, continuous, report_timestep] may be included in ‘reportPredConfigToAddModList’.

On the other hand, the measurement prediction configuration IE may be included in the measurement configuration IE. In this case, the aforementioned ‘measPredId’ may be included in ‘measIdToAddModList’, the aforementioned ‘useModelId’ may be included in ‘measIdToAddModList’, and the aforementioned pair [inputWindowSize, outputWindowSize] may be included in ‘measObjectToAddModList’. Also, in this case, the aforementioned set of [event, duration, continuous, report_timestep] may be included in ‘reportConfigToAddModList’.

Meanwhile, each field of the measurement prediction configuration IE may be configured in the same format as each field of the measurement configuration IE. In addition, the measurement prediction report message may be configured in the same format as the measurement report message. Also, the measurement prediction result IE may be configured in the same format as the measurement result IE. However, the measurement prediction result information may additionally include a flag indicating that it includes the prediction result. In addition, the measurement prediction result information may additionally include a specific time indicating that the prediction result is a prediction result for a time after the specific time.

Meanwhile, the terminal may predict a received signal strength for a time after a specific time based on a received signal strength measurement result. As shown in Equation 1, the terminal may add a predicted change amount Δ to a sum of values obtained by multiplying k received signal strength measurement results among received signal strength measurement results until now by the respective weights wᵢ, thereby predicting the received signal strength after the specific time. Here, Mᵢ may be a received signal strength measurement result of an i-th period, and MEₙ₊₁ may be a received signal strength prediction result for a (n+1)-th period.

$$M {E}_{n + 1} = {\sum }_{i = n - k}^{n} {w}_{i} {M}_{i} + Δ \qquad [ Equation 1 ]$$

On the other hand, the terminal may predict a received signal strength after a specific time based on a received signal strength measurement result and a received signal strength prediction result. As shown in Equation 2, the terminal may add a predicted change amount Δ to a sum of values obtained by multiplying k received signal strength measurement results among received signal strength measurement results until now by the weights wᵢ and values obtained by multiplying a received signal strength prediction result from the current time before the specific time by weights wⱼ. Here, Mᵢ may be a received signal strength measurement result of the i-th measurement period, MEⱼ may be a received signal strength prediction result of the j-th measurement period, and MEₙ₊₁ may be a received signal strength prediction result of the (n+1)-th measurement period.

$$M {E}_{n + 1} = {\sum }_{i = n - k}^{n} {w}_{i} {M}_{i} + {\sum }_{j = n + 1}^{n + l - 1} {w}_{j} M {E}_{j} + Δ \qquad [ Equation 2 ]$$

On the other hand, the terminal may predict a received signal strength after a specific time based on a received signal strength calculation result without a received signal strength measurement result. As shown in Equation 3, the terminal may predict a received signal strength after a specific time by adding a predicted change amount Δ to a sum of values obtained by multiplying k received signal strength calculation results among received signal strength calculation results until now by the respective weights wᵢ. Here, MCᵢ may be a received signal strength calculation result of the i-th measurement period.

$$M {E}_{n + 1} = {\sum }_{i = n - k}^{n} {w}_{i} M {C}_{i} + Δ \qquad [ Equation 3 ]$$

On the other hand, the terminal may predict a received signal strength after a specific time based on a received signal strength calculation result and a received signal strength prediction result. As shown in Equation 4, the terminal may predict a received signal strength after a specific time by adding a predicted change amount Δ to a sum of values obtained by multiplying k received signal strength calculation results among received signal strength measurement results until now by the respective weights wᵢ and values obtained by multiplying the received signal strength prediction result by the respective weights wⱼ. Here, MCᵢ may be a received signal strength calculation result of the i-th measurement period. MEⱼ may be a received signal strength prediction result of the j-th measurement period, and MEₙ₊₁ may be a received signal strength prediction result of the (n+1)-th measurement period.

$$M {E}_{n + l} = {\sum }_{i = n - k}^{n} {w}_{i} M {C}_{i} + {\sum }_{j = n + 1}^{n + l - 1} {w}_{j} M {E}_{j} + Δ \qquad [ Equation 4 ]$$

In this case, the terminal may calculate an approximate received signal strength based on transmission parameters including a transmission power and an antenna gain of the base station, reception parameters including an antenna gain of the terminal, a distance calculated from a reference position of the base station and a current or expected position of the terminal, whether a path between the terminal and the base station is in an line-of-sight (LOS) or non-line-of-sight (NLOS) environment, and/or the like. To this end, the base station may inform the terminal of the transmission parameters, the reference position, and/or the like. Accordingly, the terminal may receive information on the transmission parameters and reference position from the base station.

Meanwhile, the terminal may predict a change amount in consideration of the terminal's movement speed, position information, movement direction, and/or the like. Here, the movement speed, position information, and movement direction may each be current state information or state information predicted after a specific time. In this case, the terminal may obtain its position after a specific time from information on a preconfigured route. In addition, the terminal may utilize a distance calculated from a reference position of the base station and a current or expected position of the terminal in order to increase accuracy of the change amount. To this end, the base station may inform the terminal of the reference position and the like. Accordingly, the terminal may receive information on the reference position and the like from the base station. In addition, the terminal may more accurately predict the change amount by using information on the existing change amount in consideration of the movement speed, position information, and movement direction of the terminal. Meanwhile, the signal strength may be RSRP, RSRQ, SINR, or the like.

The terminal may perform prediction of RSRP, RSRQ, and/or SINR measurement to which the L1 filtering is applied according to configuration of the base station. In addition, the terminal may report, to the base station, the RSRP, RSRQ, and/or SINR measurement prediction results to which the L1 filtering is applied according to configuration of the base station. In this case, the terminal may periodically report the measurement prediction result to the base station. Alternatively, the terminal may report the measurement prediction result to the base station when requested by the base station. Alternatively, the terminal may report the measurement prediction result to the base station when a specific event condition is satisfied. Accordingly, the base station may receive the measurement prediction result from the terminal. The RSRP, RSRQ, and/or SINR to which the L1 filtering is applied may be a measurement result or a measurement prediction result of a cell or beam.

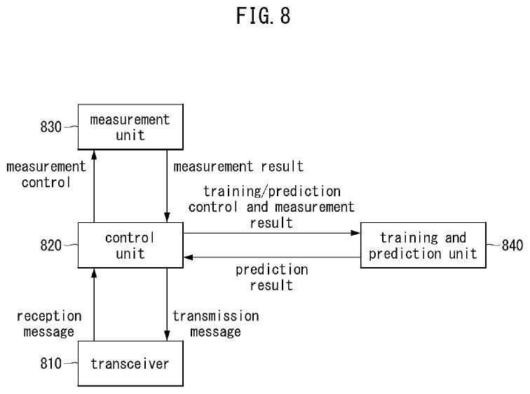

FIG. 8 is a block diagram illustrating a first exemplary embodiment of a cell change prediction apparatus in a communication system.

Referring to FIG. 8, a cell change prediction apparatus in a communication system may comprise a transceiver 810, a control unit 820, a measurement unit 830, and a training and prediction unit 840. Here, the transceiver 810 may receive a message including measurement control information and training and prediction control information from the base station, and forward the received message to the control unit 820. The control unit 820 may receive the message from the transceiver 810, and forward the measurement control information of the received message to the measurement unit 830. In addition, the control unit 820 may forward the training and prediction control information of the received message to the training and prediction unit 840.

The measurement unit 830 may receive the measurement control information from the control unit 820, and measure received signal strengths of a serving cell and a neighboring cell according to the received measurement control information. In addition, the measurement unit 830 may transmit a measurement result to the control unit 820. Accordingly, the control unit 820 may receive the measurement result from the measurement unit 830, and forward the received measurement result to the training and prediction unit 840.

The training and prediction unit 840 may receive the training and prediction control information from the control unit 820. Accordingly, the training and prediction unit 840 may perform training of a machine learning model according to the training and prediction control information. In addition, the training and prediction unit 840 may receive the measurement result from the control unit 820. Accordingly, the training and prediction unit 840 may calculate a measurement prediction result by using the measurement result according to the training and prediction control information. The training and prediction unit 840 may transmit the measurement prediction result to the control unit 820. The control unit 820 may receive the measurement prediction result from the training and prediction unit 840, and may perform a necessary operation according to the received measurement prediction result. In addition, the control unit 820 may generate a message including information to be reported to the base station based on the measurement prediction result, and forward the message to the transceiver so that it is transmitted to the base station.

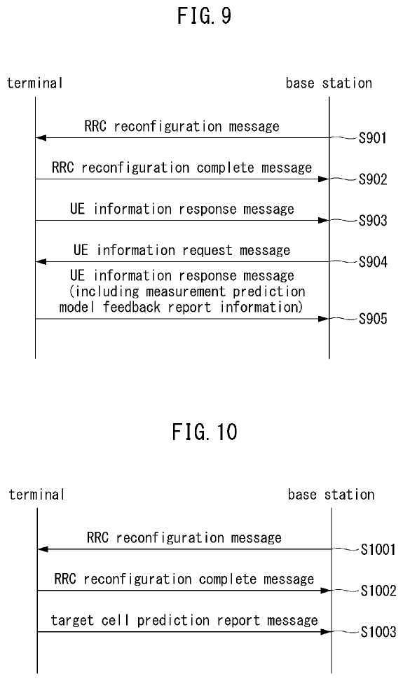

FIG. 9 is a sequence chart illustrating a first exemplary embodiment of a measurement prediction model feedback method in a communication system.

Referring to FIG. 9, a base station may generate measurement prediction model feedback configuration information and transmit it to a terminal. Then, the terminal may receive the measurement prediction model feedback configuration information from the base station. Accordingly, the terminal may perform measurement prediction model feedback according to the received measurement prediction model feedback configuration information. Here, the measurement prediction model feedback configuration information may include information on measurement prediction model feedback report information to be transmitted and a condition for transmitting a measurement prediction model feedback information availability (e.g., predictionFeedbackInfoAvailable) indicator. Here, the measurement prediction model feedback information availability indicator may be an indicator notifying presence of measurement prediction model feedback report information. Meanwhile, the measurement prediction model feedback report information may include a received signal strength measurement result at a measurement time and a received signal strength prediction result for a prediction time. In addition, the measurement prediction model feedback report information may additionally include, as information required for reducing an error between the two results, information on a received signal strength measurement result at the prediction time and information on positions of the terminal at the prediction time and the measurement time, and the like. Here, the measurement time and the prediction time may be the same.

Meanwhile, the condition for transmitting may be a condition for periodically transmitting a measurement prediction model feedback signal or the measurement prediction model feedback information availability indicator. Alternatively, the condition for transmitting may be a condition for transmitting the measurement prediction model feedback signal or the measurement prediction model feedback information availability indicator when a specific event occurs. Here, the specific event may be a case where an error between a received signal strength measurement result at a specific time and a received signal strength prediction result for the specific time has a value equal to or greater than a specific threshold. Alternatively, the specific event may be a case where a mean square error between a received signal strength measurement result and a received signal strength prediction result during a specific time period is equal to or greater than a specific error threshold.

Meanwhile, the base station may include the measurement prediction model feedback configuration information in the measurement prediction configuration information, and transmit the same to the terminal. Alternatively, the base station may configure the measurement prediction model feedback configuration information as a measurement prediction error configuration IE (i.e., measPreErrorConfig IE). Here, the measurement prediction error configuration IE may include one of machine learning loss functions.

For example, the loss function may be a mean absolute error (MAE), a mean square error (MSE), a root mean square error (RMSE), or the like. The measurement prediction error configuration IE may include a specific error threshold, so that a measurement prediction model feedback is transmitted when an error equal to or greater than the specific threshold. In addition, the measurement prediction error configuration IE may include a time step for calculating the loss function. When the time step is not specified, the terminal may use the entire measurement prediction result as a target for calculating the loss function. The measurement prediction error configuration IE may include a specific time for calculating the loss function.

Meanwhile, the base station may transmit an RRC reconfiguration message including the measurement prediction error configuration IE to the terminal (S901). Accordingly, the terminal may receive the RRC reconfiguration message including the measurement prediction error configuration IE from the base station. In addition, the terminal may configure a measurement prediction model feedback according to the measurement prediction model feedback configuration information of the measurement prediction error configuration IE. Thereafter, the terminal may transmit an RRC reconfiguration complete message to the base station in response to the RRC reconfiguration message (S902). The base station may receive the RRC reconfiguration complete message from the terminal.

Meanwhile, the terminal may inform the base station of presence of a measurement prediction model feedback report by transmitting a UE information response message including a measurement prediction model feedback information availability indicator to the base station according to the measurement prediction model feedback configuration information (S903). Alternatively, when a specific event occurs, the terminal may transmit a UE information response message including a measurement prediction model feedback information availability indicator to the base station according to the measurement prediction model feedback configuration information (S903). For example, the terminal may transmit a UE information response message to the base station when an error between a received signal strength measurement result at a specific time and a received signal strength prediction result for a prediction time is equal to or greater than a specific error threshold. Alternatively, the terminal may transmit a UE information response message to the base station when a mean square error between a received signal strength measurement result and a received signal strength prediction result during a specific time is equal to or greater than a specific error threshold. Accordingly, the base station may receive the UE information response message including the measurement prediction model feedback information available indicator from the terminal.

Meanwhile, in response to the UE information response message, the base station may transmit a UE information request message including a prediction feedback report request indicator to the terminal to request the terminal to transmit measurement prediction model feedback report information (S904). The terminal may receive the UE information request message requesting transmission of the measurement prediction model feedback report information from the base station. Then, the terminal may transmit the measurement prediction model feedback report information to the base station. In this case, the terminal may transmit the measurement prediction model feedback report information to the base station by transmitting a UE information response message including the measurement prediction model feedback report information to the base station (S905). Accordingly, the base station may receive the UE information response message including the measurement prediction model feedback report information from the terminal. Here, the measurement prediction model feedback report information may include a signal strength measurement result at a measurement time and a signal strength prediction result for a prediction time. In addition, the measurement prediction model feedback report information may further include, as information required to reduce an error between the two results, a signal strength measurement result at the prediction time, information on positions of the terminal at the prediction time and measurement time, and the like. In addition, the measurement prediction model feedback report information may include a loss function value. The loss function value may be included in the measurement prediction model feedback information availability indicator.

Alternatively, the terminal may transmit the measurement prediction model feedback report information to the base station by transmitting a UE information response message including the measurement prediction model feedback report information to the base station. The base station may receive the measurement prediction model feedback report information from the terminal, improve machine learning performance of the measurement prediction model based on the measurement prediction model feedback report information, and update the measurement prediction model of the terminal as needed. On the other hand, when the terminal performs model training for the measurement prediction model, the terminal may not transmit measurement prediction model feedback report information to the base station, and may train the measurement prediction model by itself to improve machine learning performance.

FIG. 10 is a sequence chart illustrating a first exemplary embodiment of a target cell prediction method in a communication system.

Referring to FIG. 10, in a target cell prediction method, the base station may configure target cell prediction information to the terminal. The terminal may perform target cell prediction according to the configured target cell prediction information and report a target cell prediction result to the base station.

Looking at this in more detail, the base station may generate the target cell prediction information enabling target cell prediction to be performed as needed for a terminal capable of target cell prediction according to capability of the terminal, network configuration information, and the like. In this manner, the base station may generate the target cell prediction information suitable for the terminal, configure it as a target cell prediction configuration IE (i.e., targetPredictionConfig IE), and transmit it to the terminal through an RRC reconfiguration message (S1001).

Here, the target cell prediction information may be information for determining a target cell based on received signal strengths measured for neighboring cells at a specific time. For example, the target cell prediction information may be information for determining a cell having a received signal strength that satisfies a specific event among the received signal strengths of the neighboring cells measured at the specific time as a target cell. Here, the specific event may be an A3 event defined in the NR or LTE specifications.

Alternatively, the target cell prediction information may be information for determining, as a result of predicting the signal strengths of neighboring cells at a specific time, a cell having a predicted received signal strength satisfying a specific event among the predicted received signal strengths of neighboring cells as a target cell. Alternatively, the target cell prediction information may be information for considering measurement results of signal strengths of neighboring cells at a first specific time and prediction results of signal strengths of the neighboring cells for a second specific time, and determining a cell having a received signal strength satisfying a specific event in both the measurement result and the prediction result as a target cell. Alternatively, the target cell prediction information may be information for considering a first result obtained by predicting signal strengths of neighboring cells for a first specific time and a second result obtained by predicting signal strengths of the neighboring cells for a second specific time, and determining a cell having a received signal strength satisfying a specific event in both the first result and the second result as a target cell.

Alternatively, the target cell prediction information may be information for considering a result obtained by measuring signal strengths of neighboring cells at a first specific time, a result obtained by predicting signal strengths of the neighboring cells for a second specific time, and a result obtained by predicting signal strengths of the neighboring cells for a third specific time, and determining a cell having a received signal strength satisfying a specific event in all the results as a target cell. Alternatively, the target cell prediction information may be information for calculating target cell fitness levels of the serving cell and neighboring cells by considering measurement results of received signal strengths measured for the serving cell and neighboring cells, prediction results of the received signal strengths, and weights such as load conditions, and determining a target cell based on the calculated target cell fitness levels. In this case, the terminal may determine a cell corresponding to a case in which the highest fitness level among the fitness levels of the neighboring cells satisfies a specific condition as a target cell. Alternatively, the terminal may determine a cell corresponding to a case in which the highest fitness level among the fitness levels of the neighboring cells satisfies a specific condition as a target cell. Alternatively, when the fitness level of the serving cell satisfies a first specific condition and the highest fitness level among the fitness levels of the neighboring cells satisfies a second specific condition, the terminal may determine the corresponding neighboring cell as a target cell.

Accordingly, the terminal may receive the RRC reconfiguration message including the target cell prediction configuration IE from the base station. The terminal may perform target cell prediction according to the target cell prediction information of the received target cell prediction configuration IE. In this case, the base station may inform a load state of the base station to the terminal as needed. The terminal may receive the information on the load state of the base station from the base station. Upon receiving the information, the terminal may transmit an RRC reconfiguration complete message to the base station in response (S1002).

Meanwhile, the terminal may calculate the fitness levels based on measurement results of received signal strengths of the serving cell and neighboring cells, prediction results of received signal strengths, and weights such as load conditions according to the target cell prediction information. When the highest fitness level among the fitness levels of neighboring cells satisfies a specific condition, the terminal may determine a cell corresponding to the highest fitness level as a target cell. Alternatively, when the fitness level of the serving cell satisfies a first specific condition and the highest fitness level among the fitness levels of the neighboring cells satisfies a second specific condition, the terminal may determine the corresponding neighboring cell as a target cell.

In this case time, in order to reduce the ping-pong probability, when a time for which a predicted received signal strength of the target cell better than a predicted received signal strength of the serving cell is determined to be less than a specific threshold based on a prediction result of the received signal strength of the target cell and a prediction result of the received signal strength of the serving cell, the terminal may not perform the handover procedure. Here, the specific threshold may be the minimum time-of-stay.

Thereafter, when the target cell is determined according to the configured target cell prediction information, the terminal may transmit a target cell prediction report message including a target cell prediction result to the base station (S1003). The target cell prediction report message may include the target cell prediction result. Here, the target cell prediction result may include information on the determined target cell. The target cell prediction report message may further include information on a remaining time until the specific time used for the target cell determination or an absolute time of the specific time used for the target cell determination. In addition, the target cell prediction report message may further include a measurement result IE (i.e., measResults IE) that is the measurement result of the received signal strength, and may further include a measurement prediction result IE (i.e., measPredictionResults IE) that is the measurement prediction result of the received signal strength.

Alternatively, if the terminal is configured to perform a handover when a specific target cell is determined according to the target cell prediction, the terminal may perform the handover to the corresponding target cell without transmitting the target cell prediction report message to the base station. In this case, the terminal may transmit the target cell prediction report message to a base station accessed through the handover procedure.

Alternatively, the terminal may report information on a cell whose probability of being determined as a target cell according to target cell prediction is greater than or equal to a specific threshold to the base station. Alternatively, the terminal may report information on up to N cells to the base station in the order of high probability of being determined as a target cell according to target cell prediction. In this case, the information reported by the terminal may include information on the cell(s), information on the probability of being determined as a target cell, and/or the like.

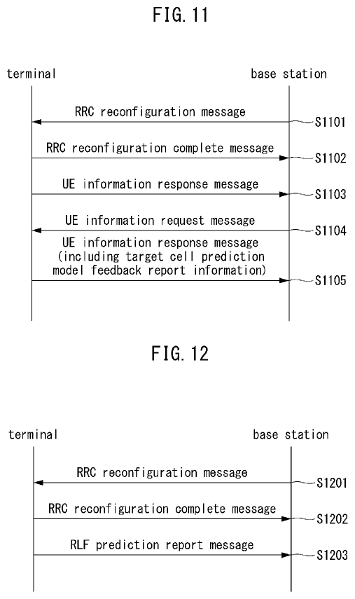

FIG. 11 is a sequence chart illustrating a first exemplary embodiment of a target cell prediction model feedback method in a communication system.

Referring to FIG. 11, the base station may generate target cell prediction model feedback configuration information and transmit it to the terminal. Then, the terminal may receive the target cell prediction model feedback configuration information from the base station. Accordingly, the terminal may perform target cell prediction model feedback according to the received target cell prediction model feedback configuration information. Here, the target cell prediction model feedback configuration information may include a condition for transmitting target cell prediction model feedback information. Alternatively, the target cell prediction model feedback configuration information may include a condition for transmitting a target cell prediction model feedback information availability (i.e., predictionFeedbackInfoAvailable) indicator. Here, the target cell prediction model feedback information availability indicator may be an indicator notifying presence of target cell prediction model feedback report information. Meanwhile, the target cell prediction model feedback report information may include a target cell fitness level measurement result after handover execution and a target cell fitness level prediction result before handover execution. In addition, the target cell prediction model feedback report information may additionally include, as information required for reducing an error between the two results, signal strength measurement results and prediction results at a measurement time and a prediction time, information on positions of the terminal at the prediction time and the measurement time, and the like.

Meanwhile, the condition for transmitting may be a condition for periodically transmitting a target cell prediction model feedback signal or the target cell prediction model feedback information availability indicator. Alternatively, the condition for transmitting may be a condition for transmitting the target cell prediction model feedback signal or the target cell prediction model feedback information availability indicator when a specific event occurs. Here, the specific event may be a case where an error between a target cell fitness level measurement result after handover execution and a target cell fitness level prediction result before handover execution is equal to or greater than a specific threshold.

Meanwhile, the base station may include the target cell prediction model feedback configuration information in the target cell prediction information, and transmit the same to the terminal. Alternatively, the base station may configure the target cell prediction model feedback configuration information as a target cell prediction error configuration IE (i.e., predictionErrorConfig IE). Here, the target cell prediction error configuration IE may include one of machine learning loss functions. For example, the loss function may be MAE, MSE, RMSE, or the like. The target cell prediction error configuration IE may include a specific error threshold to transmit model feedback information when an error greater than or equal to the specific error threshold occurs.

Meanwhile, the base station may transmit an RRC reconfiguration message including the target cell prediction error configuration IE to the terminal (S1101). Accordingly, the terminal may receive the RRC reconfiguration message including the target cell prediction error configuration IE from the base station. Then, the terminal may perform target cell prediction model feedback according to the target cell prediction model feedback configuration information of the target cell prediction error configuration IE. Thereafter, the terminal may transmit an RRC reconfiguration complete message to the base station in response to the RRC reconfiguration message (S1102). The base station may receive the RRC reconfiguration complete message from the terminal.

Meanwhile, the terminal may transmit a UE information response message including a target cell prediction model feedback information availability indicator to the base station according to the target cell prediction model feedback configuration information to inform the base station that there is a target cell prediction model feedback report (S1103). Alternatively, when a specific event occurs, the terminal may transmit a UE information response message including a target cell prediction model feedback information availability indicator to the base station according to the target cell prediction model feedback configuration information (S1103). For example, the terminal may transmit the UE information response message to the base station when an error between a fitness level measurement result of the target cell after handover execution and a fitness level prediction result of the target cell before handover execution is equal to or greater than a specific threshold. Accordingly, the base station may receive the UE information response message including the target cell prediction model feedback information availability indicator from the terminal.

Meanwhile, the base station may transmit a UE information request message including a target cell prediction model feedback report request indicator to the terminal in response to the UE information response message, and may request transmission of the target cell prediction model feedback report information from the terminal (S1104). The terminal may receive the UE information request message requesting transmission of the target cell prediction model feedback report information from the base station, and then transmit the target cell prediction model feedback report information to the base station. In this case, the terminal may transmit the target cell prediction model feedback report information to the base station by transmitting a UE information response message including the target cell prediction model feedback report information to the base station (S1105). Accordingly, the base station may receive the UE information response message including the target cell prediction model feedback report information from the terminal. Here, the target cell prediction model feedback report information may include the target cell fitness level measurement result after handover execution and the target cell level fitness level prediction result before handover execution. In addition, the target cell prediction model feedback report information may additionally include, as information required for reducing an error between the two results, signal strength measurement results and prediction results at a measurement time and for a prediction time, information on positions of the terminal at the prediction time and the measurement time, and the like. In addition, the target cell prediction model feedback report information may include a loss function value. Alternatively, the loss function value may be included in the target cell prediction model feedback information availability indicator.

Alternatively, the terminal may transmit the target cell prediction model feedback report information to the base station by transmitting a UE information response message including the target cell prediction model feedback report information to the base station. The base station may receive the target cell prediction model feedback report information from the terminal, improve machine learning performance of the target cell prediction model based on the target cell prediction model feedback report information, and update the target cell prediction model of the terminal as needed. On the other hand, when the terminal performs model training for the target cell prediction model, the terminal may not transmit the target cell prediction model feedback report information to the base station, and the terminal may train the target cell prediction model by itself to improve machine learning performance.

FIG. 12 is a sequence chart illustrating a first exemplary embodiment of an RLF prediction method in a communication system.

Referring to FIG. 12, in an RLF prediction method, the base station may configure RLF prediction information to the terminal. The terminal may perform RLF prediction according to the configured RLF prediction information and report an RLF prediction result to the base station.

The base station may generate the RLF prediction information enabling RLF prediction as needed for a terminal capable of RLF prediction according to capability of the terminal, network configuration information, and the like. In this manner, the base station may generate RLF prediction information suitable for the terminal, configure it as an RLF prediction configuration IE (i.e., rlfPredictionConfig IE), and transmit it to the terminal through an RRC reconfiguration message (S1201). The RLF prediction configuration IE may include information for predicting an RLF. For example, the information for predicting an RLF may be information for declaring an RLF when a prediction result of a received signal strength for a time after a specific time is lower than a specific threshold.

Accordingly, the terminal may receive the RRC reconfiguration message including the RLF prediction configuration IE from the base station. The terminal may perform RLF prediction according to the received RLF prediction information. Upon receiving the RLF prediction information, the terminal may transmit an RRC reconfiguration complete message to the base station in response (S1202).

Meanwhile, the terminal may predict a received signal strength for a time after a specific time according to the RLF prediction information. The terminal may declare an RLF when the predicted result is lower than a specific threshold.

Thereafter, when the terminal may declare the RLF according to the configured RLF prediction information, the terminal may transmit an RLF prediction report message including an RLF prediction result to the base station (S1203). The RLF prediction report message may include the RLF prediction result. Here, the RLF prediction result may include information on the predicted RLF. The RLF prediction report message may further include a remaining time until a time at which the RLF is predicted to occur or an absolute time of the time at which the RLF is predicted to occur. In addition, the RLF prediction report message may additionally include a measurement result IE (i.e., measResults IE) that is a signal strength measurement result, and may further include a measurement prediction result IE (i.e., measPredictionResults IE) that is a signal strength measurement prediction result.

Alternatively, when occurrence of an RLF is predicted, the terminal may not transmit an RLF prediction report message to the base station, and the terminal may declare an RLF in advance. Accordingly, the terminal may perform a radio link recovery procedure by performing an RRC re-establishment procedure. In this case, the terminal may transmit an RLF prediction report message to a base station accessed through the radio link recovery procedure.

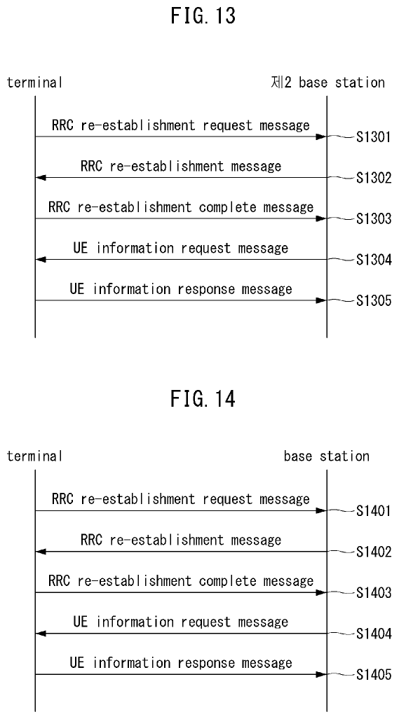

FIG. 13 is a sequence chart illustrating a first exemplary embodiment of an RLF recovery method in a communication system.

Referring to FIG. 13, the terminal may predict occurrence of an RLF with a first base station. In this case, the terminal may declare an RLF in advance. Then, the terminal may transmit an RRC re-establishment request message to a second base station (S1301). Then, the second base station may receive the RRC re-establishment request message from the terminal. The second base station may determine whether context of the terminal is valid based on information in the RRC re-establishment request message. As a result of the determination, if the context of the terminal is valid, the second base station may transmit an RRC re-establishment message to the terminal in response to the RRC re-establishment request message (S1302). On the other hand, the second base station may transmit an RRC re-establishment rejection message to the terminal when the context of the terminal is determined to be not valid as a result of the determination. Accordingly, the terminal may receive the RRC re-establishment message or the RRC re-establishment rejection message from the second base station. Through this procedure, the terminal may access the second base station. When receiving the RRC re-establishment rejection message, the terminal may access the second base station through an initial access procedure.

Meanwhile, the terminal may have RLF prediction result information to be reported to the second base station. In this case, the terminal may transmit an RRC re-establishment complete message including an RLF prediction information availability (i.e., rlfPredictionInfoAvailable) indicator to the second base station to inform presence of an RLF prediction report to the second base station (S1303). Accordingly, the second base station may receive the RRC re-establishment complete message including the RLF prediction information availability indicator from the terminal.

Meanwhile, the second base station may transmit a UE information request message including an RLF report request (i.e., rlfPredictionReportReq) indicator to the terminal in response to the UE information response message to request transmission of the RLF prediction report information (i.e., rlfPredictionReport) (S1304). The terminal may receive a UE information request message requesting transmission of the RLF prediction report information from the second base station, and then transmit the RLF prediction report information to the second base station.

In this case, the terminal may transmit the RLF prediction report information to the second base station by transmitting a UE information response message including the RLF prediction report information to the second base station (S1305). Accordingly, the second base station may receive the UE information response message including the RLF prediction report information from the terminal. The second base station receiving the RLF prediction report information may improve handover performance by improving algorithms such as handover parameters, if necessary, in cooperation with another base stations related to the RLF prediction report information.

Meanwhile, the terminal may maintain variable RLF prediction report (i.e., VarrlfPredictionReport) information. The RLF prediction variable report information may include information for configuring the RLF prediction report.

Alternatively, the first base station may not have the preconfigured received signal strength measurement prediction configured information when configuring the RLF prediction information for the terminal. In this case, the second base station may configure signal strength measurement prediction configuration information including the RLF prediction information to the terminal. Here, the signal strength measurement prediction configuration information may be configured with the measPredictionConfig IE described above, and transmit it to the terminal by including it in the RRC reconfiguration message.

FIG. 14 is a sequence chart illustrating a first exemplary embodiment of a RLF prediction model feedback method in a communication system.

Referring to FIG. 14, the base station may generate RLF prediction model feedback configuration information and transmit it to the terminal. Then, the terminal may receive the RLF prediction model feedback configuration information from the base station. Accordingly, the terminal may execute RLF prediction model feedback according to the received RLF prediction model feedback configuration information. Here, the RLF prediction model feedback configuration information may include information on RLF prediction model feedback report information to be transmitted and a condition for transmitting RLF prediction model feedback information availability (i.e., rlfpredictionFeedbackInfoAvailable) indicator. Here, the RLF prediction model feedback information availability indicator may be an indicator indicating existence of the RLF prediction model feedback report information. Meanwhile, the RLF prediction model feedback report information may include a signal strength measurement result and a signal strength prediction result.

Meanwhile, the condition for transmitting may be a condition for transmitting a RLF prediction model feedback to the base station when an error greater than a specific threshold value occurs between the signal strength measurement result and the signal strength prediction result. Meanwhile, the base station may include the RLF prediction model feedback configuration information in the RLF prediction information, and transmit the same to the terminal. Alternatively, the base station may configure the RLF prediction model feedback configuration information as a RLF prediction error configuration IE (i.e., predictionErrorConfig IE). Here, the RLF prediction error configuration IE may include one of loss functions for machine learning.

For example, the loss function may be MAE, MSE, RMSE, and/or the like. The RLF prediction error configuration IE may include a specific threshold to transmit model feedback when an error greater than or equal to the specific threshold occurs.

Meanwhile, the terminal may transmit an RRC re-establishment request message to the base station (S1401). Then, the base station may receive the RRC re-establishment request message from the terminal. The base station may determine whether context of the terminal is valid based on information in the RRC re-establishment request message. As a result of the determination, if the context of the terminal is valid, the base station may transmit an RRC re-establishment message to the terminal in response to the RRC re-establishment request message (S1402). As a result of the determination, the base station may transmit an RRC re-establishment rejection message to the terminal when the context of the terminal is not valid. Accordingly, the terminal may receive the RRC re-establishment message or the RRC re-establishment rejection message from the base station. Through this procedure, the terminal may access the second base station. When receiving the RRC re-establishment rejection message, the terminal may access the second base station through an initial access procedure.

Meanwhile, the terminal may notify the base station that there is a RLF prediction model feedback report by transmitting an RRC re-establishment complete message including an indicator indicating that the RLF prediction model feedback information is available according to the RLF prediction model feedback configuration information (S1403). For example, when a specific event occurs, the terminal may transmit an RRC re-establishment complete message including an RLF prediction model feedback information availability indicator to the base station according to the RLF prediction model feedback configuration information (S1403). For example, the terminal may transmit the RRC re-establishment complete message including the RLF prediction model feedback information availability indicator to the base station when an error equal to or greater than a specific threshold occurs between a signal strength measurement result and a signal strength prediction result. Accordingly, the base station may receive the RRC re-establishment complete message including the RLF prediction model feedback information availability indicator from the terminal.

Meanwhile, the base station may transmit a UE information request message including an RLF prediction model feedback report request indicator to the terminal in response to the RRC re-establishment complete message to request transmission of the RLF prediction model feedback report information from the terminal (S1404). The terminal may receive the UE information request message requesting transmission of the RLF prediction model feedback report information from the base station. Then, the terminal may transmit the RLF prediction model feedback report information to the base station. In this case, the terminal may transmit the RLF prediction model feedback report information to the base station by transmitting a UE information response message including the RLF prediction model feedback report information to the base station (S1405). Accordingly, the base station may receive the UE information response message including the RLF prediction model feedback report information from the terminal. Here, the RLF prediction model feedback report information may include the signal strength measurement result and the signal strength prediction result. In addition, the RLF prediction model feedback report information may additionally include, as information required for reducing the error between the two results, strength measurement results and prediction results at a measurement time and for the prediction time, information on positions of the terminal at the prediction time and the measurement time, and the like. In addition, the RLF prediction model feedback report information may include a loss function value. Alternatively, the loss function value may be included in the RLF prediction model feedback information availability indicator.

Alternatively, the terminal may transmit the RLF prediction model feedback report information to the base station by transmitting a UE information response message including the RLF prediction model feedback report information to the base station. The base station may receive the RLF prediction model feedback report information from the terminal, improve machine learning performance of the RLF prediction model based on the RLF prediction model feedback report information, and update the RLF prediction model of the terminal as needed. On the other hand, when the terminal performs model training for the RLF prediction model, the terminal may not transmit the RLF prediction model feedback report information to the base station, and the terminal may train the RLF prediction model by itself to improve machine learning performance.

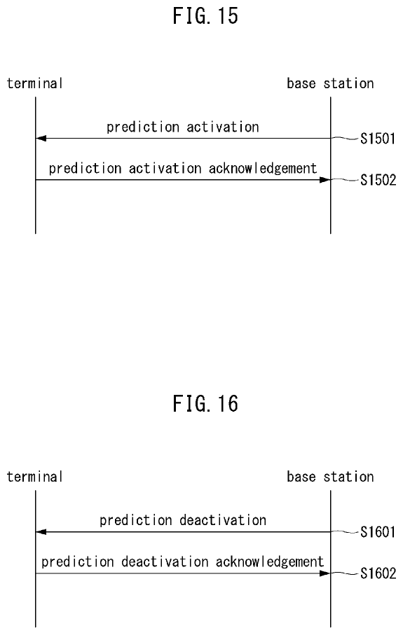

FIG. 15 is a sequence chart illustrating a first exemplary embodiment of a prediction activation method for a terminal in a communication system.

Referring to FIG. 15, the base station may transmit a prediction activation message to the terminal (S1501). Then, the terminal may receive the prediction activation message from the base station. The prediction activation message may include an ID of prediction configuration information preconfigured in the terminal. The terminal may activate prediction according to the preconfigured prediction configuration information according to the prediction activation message. When the prediction is performed by the layer 1 (L1), that is, the physical layer, the physical layer may be indicated to activate the prediction. When the prediction is performed by the layer 3, that is, the RRC layer, the RRC layer may be indicated to activate the prediction. Meanwhile, the prediction activation message may be an RRC message or a MAC control message. In response to the prediction activation message, the terminal may transmit a prediction activation acknowledgment message to the base station (S1502). Meanwhile, the prediction activation confirmation response message may be an RRC message or a MAC control message. On the other hand, transmission of the prediction activation acknowledgement message may be omitted.

FIG. 16 is a sequence chart illustrating a first exemplary embodiment of a prediction deactivation method for a terminal in a communication system.

Referring to FIG. 16, the base station may transmit a prediction deactivation message to the terminal (S1601). Then, the terminal may receive the prediction deactivation message from the base station. The prediction deactivation message may include an ID of prediction configuration information preconfigured in the terminal. The terminal may deactivate prediction according to the preconfigured prediction configuration information according to the prediction deactivation message. When the prediction is performed by the layer 1, that is, the physical layer, the physical layer may be indicated to inactivate the prediction. When the prediction is performed by the layer 3, that is, the RRC layer, the RRC layer may be indicated to deactivate the prediction. Meanwhile, the prediction deactivation message may be an RRC message or a MAC control message. In response to the prediction deactivation message, the terminal may transmit a prediction deactivation acknowledgment message to the base station (S1602). Meanwhile, the prediction deactivation acknowledgment message may be an RRC message or a MAC control message. On the other hand, transmission of the prediction deactivation acknowledgment message may be omitted.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. An operation method of a terminal, comprising:
receiving, from a serving base station, measurement configuration information and measurement prediction configuration information;
measuring signal strengths of the serving base station and a neighboring base station according to the measurement configuration information;
predicting signal strengths of the serving base station and the neighboring base station based on a result of measuring the signal strengths of the serving base station and the neighboring base station, according to the measurement prediction configuration information; and
transmitting, to the serving base station, a report message including the predicted signal strengths of the serving base station and the neighboring base station according to the measurement prediction configuration information.

2. The operation method according to claim 1, wherein the measurement prediction configuration information includes information on a second time, a first condition, and a second condition, and the terminal is configured to perform:
measuring the signal strengths of the serving base station and the neighboring base station at a first time according to the measurement configuration information;
in response to that a first signal strength of the serving base station and a second signal strength of the neighboring base station measured at the first time satisfy the first condition, predicting a first predicted signal strength of the serving base station and a second predicted signal strength of the neighboring base station by using a first measurement prediction model according to the measurement prediction configuration information, the first predicted signal strength being a signal strength predicted for the serving base station to have at the second time, and the second predicted signal strength being a signal strength predicted for the neighboring base station to have at the second time; and
in response to that the first predicted signal strength and the second predicted signal strength satisfy the second condition, transmitting the report message to the serving base station, the report message including information on the first predicted signal strength and the second predicted signal strength.

3. The operation method according to claim 1, wherein a first time difference between the first time and the second time is a predetermined trigger time, which is a time to trigger (TTT).

4. The operation method according to claim 1, wherein the report message is transmitted to the serving base station at a time between the first time and the second time.

5. The operation method according to claim 2, further comprising, when the measurement prediction configuration information further includes a third time obtained by adding a minimum time-of-stay to the first time and information of a third condition, predicting a third predicted signal strength of the serving base station and a fourth predicted signal strength of the neighboring base station by using the first measurement prediction model, the third predicted signal strength being a signal strength predicted for the serving base station to have at the third time, and the fourth predicted signal strength being a signal strength predicted for the neighboring base station to have at the third time,
wherein when the third predicted signal strength and the fourth predicted signal strength satisfy the third condition, the terminal does not transmit the report message to the serving base station.

6. The operation method according to claim 5, wherein:
the second condition is an A3 event, and the A3 event occurs when the second predicted signal strength is higher than the first predicted signal strength by a first offset or more; and
the third condition is an A7 event, and the A7 event occurs when the third predicted signal strength is higher than the fourth predicted signal strength by the first offset or more.

7. The operation method according to claim 2, further comprising:
predicting a fifth predicted signal strength of the serving base station and a sixth predicted signal strength of the neighboring base station by using the first measurement prediction model, the fifth predicted signal strength being a signal strength predicted for the serving base station to have at a fourth time between the first time and the second time, and the sixth predicted signal strength being a signal strength predicted for the neighboring base station to have at the fourth time,
wherein when the fifth predicted signal strength and the sixth predicted signal strength do not satisfy the second condition, the terminal does not transmit the report message to the serving base station.

8. The operation method according to claim 2, further comprising:
receiving, from the serving base station, information on a fifth time and a fourth condition and model feedback configuration information requesting transmission of a model feedback signal for the first measurement prediction model;
obtaining a measured signal strength by measuring a signal strength of the serving base station at the fifth time;
predicting a predicted signal strength predicted for the serving base station to have at the fifth time by using the first measurement prediction model; and
transmitting the model feedback signal to the serving base station when the measured signal strength and the predicted signal strength satisfy the fourth condition.

9. The operation method according to claim 8, wherein the transmitting of the model feedback signal comprises:
transmitting an information availability indicator notifying presence of the model feedback signal to the serving base station when the measured signal strength and the predicted signal strength satisfy the fourth condition;
receiving a report request of the model feedback signal from the serving base station; and
transmitting the model feedback signal including information on the measured signal strength and the predicted signal strength to the serving base station.

10. An operation method of a terminal, comprising:
receiving, from a serving base station, target cell prediction information including a second time and a target cell prediction condition;
measuring signal strengths of the serving base station and a neighboring base station at a first time;
predicting signal strengths predicted for the serving base station and the neighboring base station to have at the second time by using a first target cell prediction model;
predicting the neighboring base station as a target base station based on the measured signal strengths, the predicted signal strengths, and the target cell prediction condition; and
transmitting, to the serving base station, a report message including information on the target base station.

11. The operation method according to claim 10, wherein the target cell prediction condition is a condition for determining the neighboring base station as the target base station when the measured signal strength of the neighboring base station at the first time satisfies an A3 event and the predicted signal strength predicted for the neighboring base station to have at the second time satisfies the A3 event.

12. The operation method according to claim 10, further comprising:
predicting signal strengths predicted for the serving base station and the neighboring base station to have at a third time obtained by adding a minimum time-of-stay to the first time by using the first target cell prediction model; and
calculating a difference between the predicted signal strength predicted for the serving base station to have at the third time and the predicted signal strength predicted for the neighboring base station to have at the third time,
wherein when the difference satisfies a predetermined condition, the report message is not transmitted to the serving base station.

13. The operation method according to claim 10, further comprising:
receiving, from the serving base station, model feedback configuration information requesting transmission of a model feedback signal for the first target cell prediction model;
predicting a target cell fitness level of a first base station before handover to the first base station by using the first target cell prediction model;
measuring a target cell fitness level of the first base station after the handover to the first base station; and
transmitting the model feedback signal to the target base station when the predicted target cell fitness level and the measured target cell fitness level satisfy a predetermined condition.

14. An operation method of a terminal, comprising:
receiving, from a serving base station, radio link failure (RLF) prediction information including information on a prediction time and an RLF condition;
predicting a signal strength predicted for the serving base station to have at the prediction time by using an RLF prediction model; and
in response to that the predicted signal strength of the serving base station satisfies the RLF condition, transmitting, to the serving base station, a report message including information on the predicted signal strength.

15. The operation method according to claim 14, further comprising:
in response to that the predicted signal strength of the serving base station satisfies the RLF condition, declaring an RLF; and
performing an RLF recovery procedure with another base station.

16. The operation method according to claim 14, further comprising:
receiving, from the serving base station, model feedback configuration information requesting transmission of a model feedback signal for the RLF prediction model;
predicting a signal strength predicted for the serving base station to have at the prediction time by using the RLF prediction model;
measuring a signal strength of the serving base station at the prediction time; and
in response to that the predicted signal strength and the measured signal strength satisfy a predetermined condition, transmitting the model feedback signal to the serving base station.
